(19) United States
(12) Patent Application Publication
(10) Pub. No.: US 2026/0219932 A1
(43) Pub. Date: Jul. 30, 2026

(54) ACCELERATOR OFFLOAD DEVICE AND ACCELERATOR OFFLOAD METHOD

(71) Applicant: NTT, Inc., Tokyo (JP)

(72) Inventors: Ko NATORI, Musashino-shi, Tokyo (JP); Kei FUJIMOTO, Musashino-shi, Tokyo (JP); Shogo SAITO, Musashino-shi, Tokyo (JP); Ikuo OTANI, Musashino-shi, Tokyo (JP)

(21) Appl. No.: 18/865,797

(22) PCT Filed: May 20, 2022
(86) PCT No.: PCT/JP2022/020985

§ 371 Date: Nov. 14, 2024

(51) Int. Cl. G06F 9/50; G06F 9/48

(52) U.S. Cl. CPC G06F 9/5027; G06F 9/4812; G06F 2209/509

(57) ABSTRACT

An accelerator offload device that offloads specific processing of an application to an accelerator includes: a request-related processing part that performs predetermined processing required before performing offloading to the accelerator and then notifies a request I/O part of a request to perform offloading; the request I/O part, which operates on a first CPU core and which notifies the accelerator of an offload request; a response I/O part which operates on a second CPU core different from the first CPU core and which notifies a response-related processing part of operation completion of the accelerator; the response-related processing part, which performs an operation described in the application by using an operation result of the accelerator; and an interrupt destination control part that sets an interrupt destination CPU core to which the accelerator is to raise an interrupt and which is to be used as the second CPU core.

### CROSS-REFERENCE TO RELATED APPLICATIONS

This is a National Stage Application of PCT Application No. PCT/JP2022/020985, filed on May 20, 2022. The disclosure of the prior application is considered part of the disclosure of this application, and is incorporated in its entirety into this application.

### BACKGROUND

### Technical Field

The present invention relates to an accelerator offload device and an accelerator offload method.

### Background Art

Workloads that processors are good at are different depending on the type of processor. Central processing units (CPUs) have high versatility, but are not good at operating a workload having a high degree of parallelism, whereas accelerators (hereinafter, appropriately referred to as ACCs), such as a field programmable gate array (FPGA)/(hereinafter, “/” means “or”) a graphics processing unit (GPU)/an application specific integrated circuit (ASIC), can operate the workload at high speed with high efficiency. Offload techniques, which improve overall operation time and operation efficiency by combining those different types of processors and offloading a workload that CPUs are not good at to ACCs to operate the workload, have been increasingly utilized.

Representative examples of a specific workload subjected to ACC offloading include encoding/decoding processing (forward error correction processing (FEC)) in a virtual radio access network (vRAN), audio and video media processing, and encryption/decryption processing.

FIG. 21 is a schematic diagram illustrating processing of offloading part of the processing to be operated by a CPU to an accelerator (ACC).

As illustrated in FIG. 21, an accelerator system includes hardware (HW) 10, an OS or the like 20, and an application (APL) 1 in a user space 30.

Hardware 10 includes a CPU 11 and an accelerator (ACC) 12.

ACC 12 is computing unit hardware that performs specific operation at high speed based on an input from CPU 11. Specifically, accelerator 12 is a GPU or a programmable logic device (PLD) such as an FPGA.

As indicated by the white arrow a in FIG. 21, part of processing by APL 1 (workload that CPU 11 is not good at) is offloaded to ACC 12, thereby achieving performance and power efficiency that cannot be achieved only by software (CPU processing).

Techniques of transferring data in a server include New API (NAPI), Data Plane Development Kit (DPDK), and Kernel Busy Poll (KBP).

New API (NAPI) performs, upon arrival of a packet, packet processing in response to a software interrupt request after a hardware interrupt request (see Non-Patent Literature 1).

DPDK implements a packet processing function in the user space in which applications operate and, when a packet arrives, immediately pulls the packet from the user space according to a polling model. Specifically, DPDK is a framework for performing control on a network interface card (NIC) in the user space, which has been conventionally performed by the Linux kernel (registered trademark). The largest difference from the processing by the Linux kernel is to have a polling-based reception mechanism called Pull Mode Driver (PMD). Normally, in the Linux kernel, an interrupt is generated upon arrival of data to the NIC, and reception processing is triggered by an interrupt. On the other hand, in PMD, a dedicated thread continuously performs checking data arrival and reception processing. PMD is capable of performing high-speed packet processing by eliminating overheads such as context switching and interrupts.

DPDK greatly improves the performance and throughput of packet processing, thereby securing more time for data plane application processing. However, DPDK exclusively uses computer resources such as CPUs and NICs.

### CITATION LIST

### Patent Literature

Patent Literature 1: WO 2021/130828 A

### SUMMARY OF THE INVENTION

Technical Problem Conventional methods of acquiring the operation result of an ACC in ACC offloading include a (1) interrupt method and a (2) polling method.

In the (1) interrupt method, an application detects completion of the operation via an interrupt.

In the (2) polling method, completion of the operation by the ACC is immediately detected by performing busy polling (constantly monitoring a buffer in which data is stored when the operation is completed).

Description thereof will be given in order.

FIG. 22 is an explanatory diagram of the above-described (1) interrupt method, and FIG. 23 is a schematic time-lapse diagram of the interrupt method illustrated in FIG. 22. In the description with reference to FIG. 22, the same components as those in FIG. 21 are denoted by the same reference signs.

As illustrated in FIG. 22, APL 1 requests ACC 12 to offload processing (see reference sign b in FIG. 22); and ACC 12 issues, by an interrupt (see reference sign c in FIG. 22), a notification (response) of completion of the operation.

As illustrated in FIG. 23, the application thread (CPU) requests ACC 12 to offload processing 1 being performed (see reference sign b in FIG. 23). The application thread (CPU) is able to perform other processing (here, processing 2) during the ACC offloading. As other processing is able to be performed while the processing is being offloaded to the ACC, high CPU utilization efficiency is achieved.

In the (1) interrupt method, APL 1 detects completion of the operation performed by the ACC via an interrupt (see reference sign c in FIG. 23). Due to the interrupt, the application thread (CPU) needs to suspend the in-progress processing (processing 2) and save intermediate data. In this case, the application thread (CPU) performs, by the interrupt, post-processing (e.g., forward error correction (FEC) processing) of the processing 1 and then performs the in-progress processing (continuation of the processing 2). This raises the concern of an increase in the processing time caused by the interrupt processing overhead.

FIG. 24 is an explanatory diagram for explaining the (2) polling method. FIG. 25 is a schematic time-lapse diagram of the polling method illustrated in FIG. 24. In the description with reference to FIG. 24, the same components as those in FIG. 22 are denoted by the same reference signs.

As illustrated in FIG. 24, APL 1 requests ACC 12 to offload processing (see reference sign d in FIG. 24). APL 1 performs busy polling (constantly monitors a buffer in which data is stored when the ACC completes the operation) (see reference sign e in FIG. 24). With this, APL 1 immediately detects the completion (response) of the operation by ACC 12 (see reference sign f in FIG. 24).

As illustrated in FIG. 25, the application thread (CPU) requests ACC 12 to offload processing 1 being performed (see reference sign d in FIG. 25). The application thread (CPU) continues busy polling during ACC offloading until an operation result from ACC 12 is received, without performing other processing. Due to this, CPU resources are wasted during the polling. However, the (2) polling method is capable of detecting the completion of the ACC processing at high speed by busy polling (see reference sign f in FIG. 25). After the completion of the ACC processing is detected at high speed, post-processing of the processing 1 is performed, and then the next processing (processing 2) is performed.

The advantages and disadvantages of the (1) interrupt method and the (2) polling method as methods of acquiring the operation result of the ACC in ACC offloading are summarized as follows:
The (1) interrupt method has the advantage of achieving a high CPU utilization efficiency but has the concern of an increase in the processing time due to an interrupt processing overhead.

The (2) polling method has the advantage of detecting completion of the operation by the ACC at high speed by busy polling but has the concern of an increase in the power consumption due to wasteful use of CPU resources during the polling and a decrease in the CPU resource efficiency.

In this way, it is a problem to achieve both of low latency and power saving in acquisition of an accelerator operation result.

The present invention has been made in view of such background, and it is an object of the present invention to prevent contention between interrupt processing and application processing, and between interrupt processing and another interrupt processing, thereby preventing contention overhead and achieving low latency.

### Solution to Problem

In order to solve the above described problem, an accelerator offload device that offloads specific processing of an application program to an accelerator includes: a request-related processing part; a request I/O part; a response I/O part; a response-related processing part, and an interrupt destination control part, wherein the request-related processing part is configured to perform predetermined processing required before performing offloading to the accelerator and then notify the request I/O part of a request to perform offloading, wherein the request I/O part is configured to operate on a first CPU core and configured to perform request processing of notifying the accelerator of an offload request, wherein the response I/O part is configured to operate on a second CPU core different from the first CPU core to perform response processing of notifying the response-related processing part of operation completion of the accelerator, wherein the response-related processing part is configured to perform an operation described in the application program by using an operation result of the accelerator, and wherein the interrupt destination control part is configured to set an interrupt destination CPU core to which the accelerator is to raise an interrupt and which is to be used as the second CPU core.

### Advantageous Effects of Invention

According to the present invention, it is possible to prevent contention overhead and achieve low latency by preventing contention between interrupt processing and application processing and contention between interrupt processing and another interrupt processing.

### BRIEF DESCRIPTION OF DRAWINGS

FIG. 1 is a schematic configuration diagram of an accelerator offload system according to a first embodiment of the present invention.

FIG. 2 is a schematic time-lapse diagram illustrating an overview of an operation of an accelerator offload device of the accelerator offload system according to the first embodiment of the present invention.

FIG. 3 is a flowchart illustrating operations of a response I/O part and a response-related processing part of the accelerator offload device of the accelerator offload system according to the first embodiment of the present invention.

FIG. 4 is a flowchart illustrating an operation of, when providing a dedicated shared memory between an interrupt destination core setting part of the accelerator offload device and an ACC of the accelerator offload system according to the first embodiment of the present invention, setting an interrupt destination core to the ACC by the interrupt destination core setting part.

FIG. 5 is a flowchart illustrating an operation of, when providing a dedicated shared memory between the interrupt destination core setting part of the accelerator offload device and the ACC of the accelerator offload system according to the first embodiment of the present invention, raising an interrupt by the ACC.

FIG. 6 is a flowchart illustrating an operation of, when configuring a request of the accelerator offload device of the accelerator offload system according to the first embodiment of the present invention to include information on a core to which a response is to be raised, setting an interrupt destination core to the ACC by the interrupt destination core setting part.

FIG. 7 is a flowchart illustrating an operation of, when configuring a request of the accelerator offload device of the accelerator offload system according to the first embodiment of the present invention to include information on a core to which a response is to be raised, raising an interrupt by the ACC.

FIG. 8 is a flowchart illustrating operations of a request I/O part and a request-related processing part of the accelerator offload device of the accelerator offload system according to the first embodiment of the present invention.

FIG. 9 is an operation explanatory diagram for explaining parallelization (Feature <1>) of the request and the response of the accelerator offload device of the accelerator offload system according to the first embodiment of the present invention.

FIG. 10 is an operation (Feature <2-1>) explanatory diagram of an interrupt reception core information acquisition part for dynamically setting an ACC interrupt destination according to a processing state of the accelerator offload device of the accelerator offload system according to the first embodiment of the present invention.

FIG. 11 is an operation (Feature <2-2>) explanatory diagram of the interrupt destination core setting part by a method of providing a dedicated shared memory shared with the ACC of the accelerator offload device of the accelerator offload system according to the first embodiment of the present invention.

FIG. 12 is an operation (Feature <2-2>) explanatory diagram of the interrupt destination core setting part by a method of designating a response destination at the time of requesting by the accelerator offload device of the accelerator offload system according to the first embodiment of the present invention.

FIG. 13 is an operation (Feature <3>) explanatory diagram of sleep control of the accelerator offload device of the accelerator offload system according to the first embodiment of the present invention.

FIG. 14 is a schematic configuration diagram of an accelerator offload system according to a second embodiment of the present invention.

FIG. 15 is a flowchart illustrating operations of a response I/O part and a response-related processing part of an accelerator offload device of the accelerator offload system according to the second embodiment of the present invention.

FIG. 16 is a flowchart illustrating an operation of, when providing a dedicated shared memory between an interrupt destination core setting part of the accelerator offload device and an ACC of the accelerator offload system according to the second embodiment of the present invention, setting an interrupt destination core to the ACC by an interrupt destination core setting part of an interrupt destination control part of the response I/O part.

FIG. 17 is a flowchart illustrating an operation of, when configuring a request of the accelerator offload device of the accelerator offload system according to the second embodiment of the present invention to include information on a core to which a response is to be raised, setting an interrupt destination core to the ACC by the interrupt destination core setting part of the interrupt destination control part of the response I/O part.

FIG. 18 is an operation explanatory diagram of the accelerator offload system according to the second embodiment of the present invention, for explaining a method of providing a dedicated shared memory shared with the ACC of the accelerator offload device of the accelerator offload system.

FIG. 19 is an operation explanatory diagram for explaining a method of designating a response destination at the time of requesting by the accelerator offload device of the accelerator offload system according to the second embodiment of the present invention.

FIG. 20 is a hardware configuration diagram illustrating an example of a computer that implements the function of the accelerator offload device of the accelerator offload systems according to the first and second embodiments of the present invention.

FIG. 21 is a schematic diagram illustrating processing of offloading part of the processing operated by a CPU to an accelerator (ACC).

FIG. 22 is an explanatory diagram illustrating an interrupt method.

FIG. 23 is a schematic time-lapse diagram of the interrupt method of FIG. 22.

FIG. 24 is an explanatory diagram illustrating a polling method.

FIG. 25 is a schematic time-lapse diagram of the polling method in FIG. 24.

### DESCRIPTION OF EMBODIMENTS

Hereinafter, an accelerator offload system and the like in a mode for carrying out the present invention (hereinafter, referred to as “present embodiment”) will be described with reference to the drawings.

### First Embodiment

### Overall Configuration

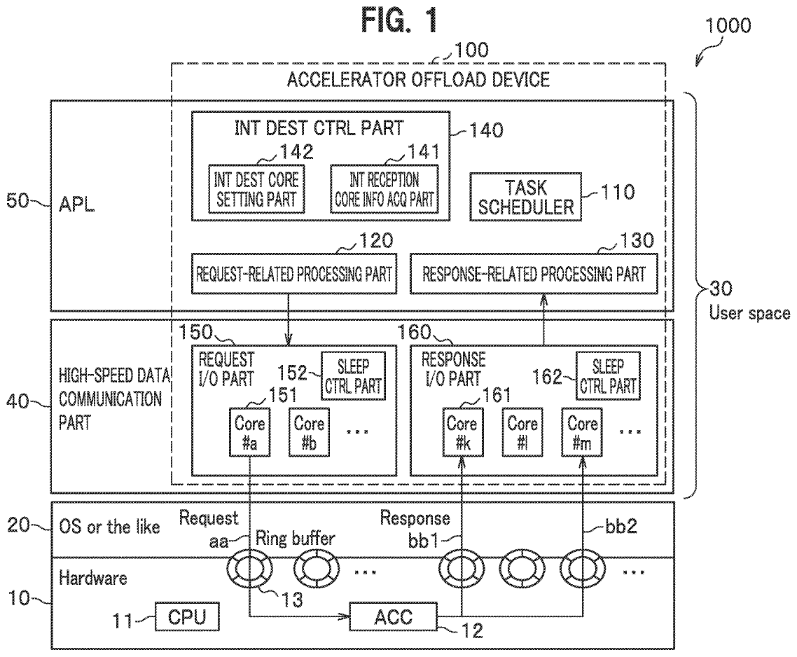

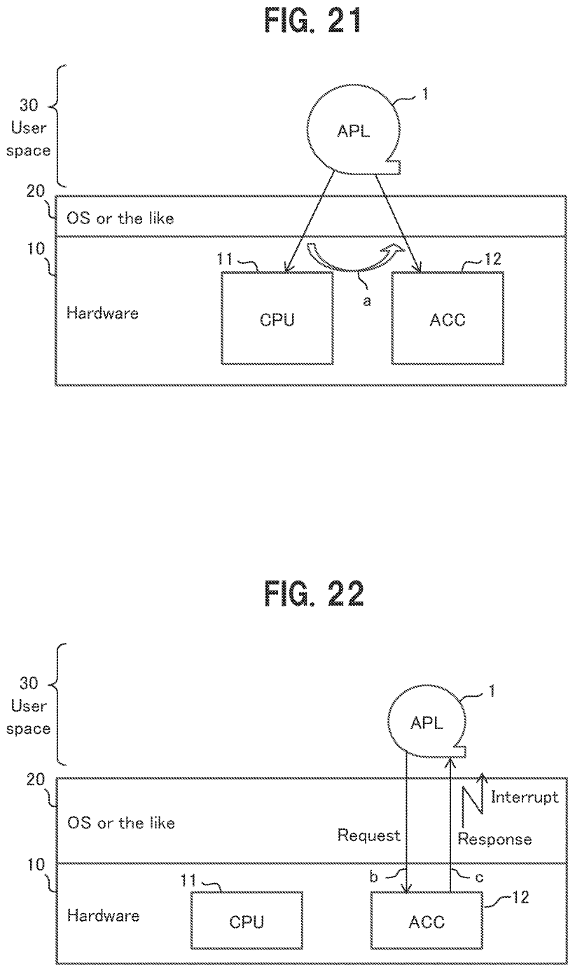

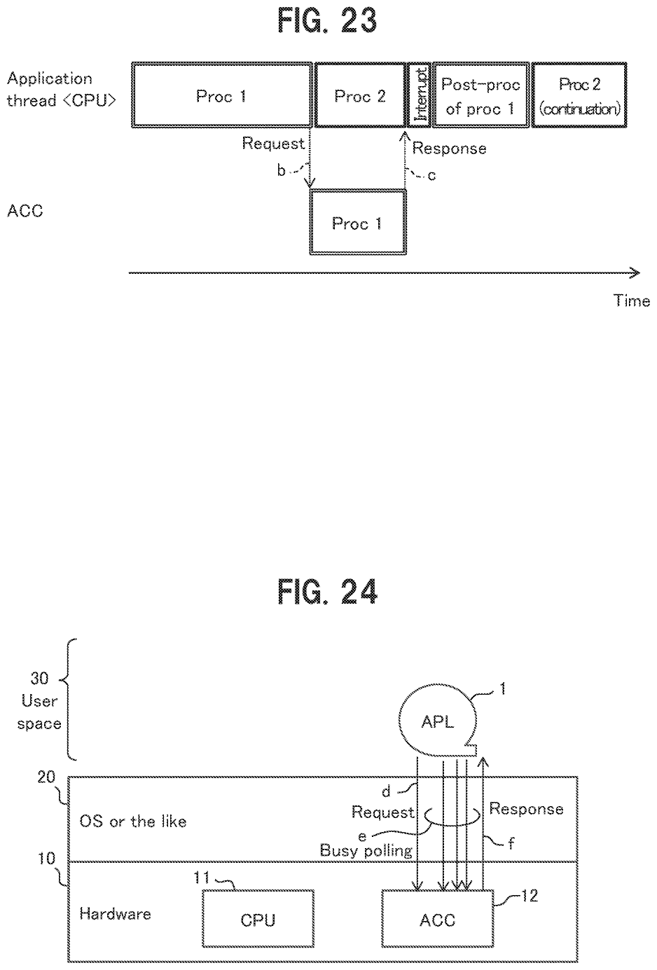

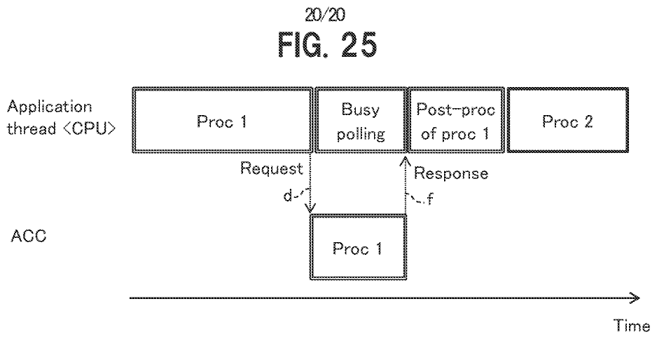

FIG. 1 is a schematic configuration diagram of an accelerator offload system according to a first embodiment of the present invention. The same components as those in FIG. 21 are denoted by the same reference signs.

As illustrated in FIG. 1, an accelerator offload system 1000 includes hardware (HW) 10, an OS or the like 20, as well as a high-speed data communication part 40 that is high-speed data transfer middleware deployed in a user space 30, an accelerator offload device 100, and an APL 50.

Hardware 10 includes a CPU 11, an accelerator (ACC) 12, and ring buffers 13.

ACC 12 is computing unit hardware that performs specific operation at high speed based on an input from CPU 11. Specifically, accelerator 12 is a GPU or a PLD such as an FPGA.

Ring buffers 13 are provided in hardware 10 to copy workloads to be processed. A request I/O part 150 and a response I/O part 160 exchange data with the accelerator via a ring buffer 13.

An application (APL) 50 (application program) is further deployed in user space 30.

APL 50 is a program executed by an application thread (CPU) in user space 30.

### Accelerator Offload Device 100

Accelerator offload device 100 includes a task scheduler 110, a request-related processing part 120, a response-related processing part 130, an interrupt destination control part 140, request I/O part 150, and response I/O part 160.

Accelerator offload device 100 is deployed on user space 30. For example, request-related processing part 120 and response-related processing part 130 are implemented in APL 50, and request I/O part 150 and Response I/O part 160 are implemented in high-speed data communication part 40 described later (as a library of a high-speed data communication layer configured with CUDA, OpenCL BBDEV API, etc.) described later.

### Task Scheduler 110

When a task that needs to be offloaded to the accelerator occurs, task scheduler 110 registers the task in a task queue of request-related processing part 120. Task scheduler 110 registers the task as a task using a CPU core different from the CPU core used by response I/O part 160.

When a task that needs to be offloaded to ACC 12 occurs, task scheduler 110 registers the task in the task queue of request-related processing part 120. At this time, task scheduler 110 registers the task as a task using a CPU core different from the CPU core used by response I/O part 160.

### Request-Related Processing Part 120

Request-related processing part 120 performs a series of processing (predetermined processing) required before offloading to the accelerator. The series of processing required before offloading to the accelerator will be described later.

Request-related processing part 120 performs the series of processing required before ACC offloading and then notifies request I/O part 150 of a request to perform ACC offloading. Note that when request I/O part 150 and request-related processing part 120 use different CPU cores, a sleep control part 121 of task scheduler 110 may cause request I/O part 150 to sleep at this timing.

### Response-Related Processing Part 130

Response-related processing part 130 performs operations described in the application program by using the operation result of ACC 12.

Response-related processing part 130 performs an operation described in APL 50 by using the operation result of ACC 12. Response-related processing part 130 may perform the processing by the CPU core used by response I/O part 160 or may perform the processing by another core.

### Interrupt Destination Control Part 140

Interrupt destination control part 140 sets an interrupt destination CPU core to be interrupted by accelerator (ACC) 12 interrupting a CPU core of response I/O part 160.

Interrupt destination control part 140 includes an interrupt reception core information acquisition part 141 and an interrupt destination core setting part 142.

Interrupt reception core information acquisition part 141 acquires interrupt reception core information.

Interrupt destination core setting part 142 sets an interrupt destination core to ACC 12 based on the interrupt reception core information acquired by interrupt reception core information acquisition part 141.

Interrupt destination control part 140 is provided in the application (APL) 50 and dynamically sets the interrupt destination CPU core of the accelerator according to an application processing state.

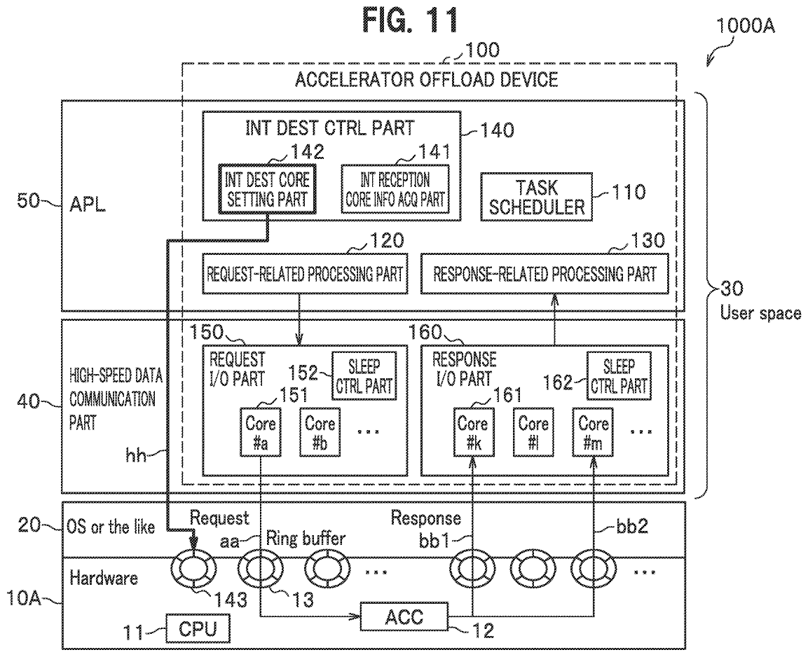

A dedicated shared memory 143 (see FIG. 11 described later) is provided between interrupt destination core setting part 142 and ACC 12, and interrupt destination core setting part 142 writes interruptible core information into the shared memory 143, and ACC 12 references the shared memory 143 to raise the interrupt to a free core (performs the interrupt).

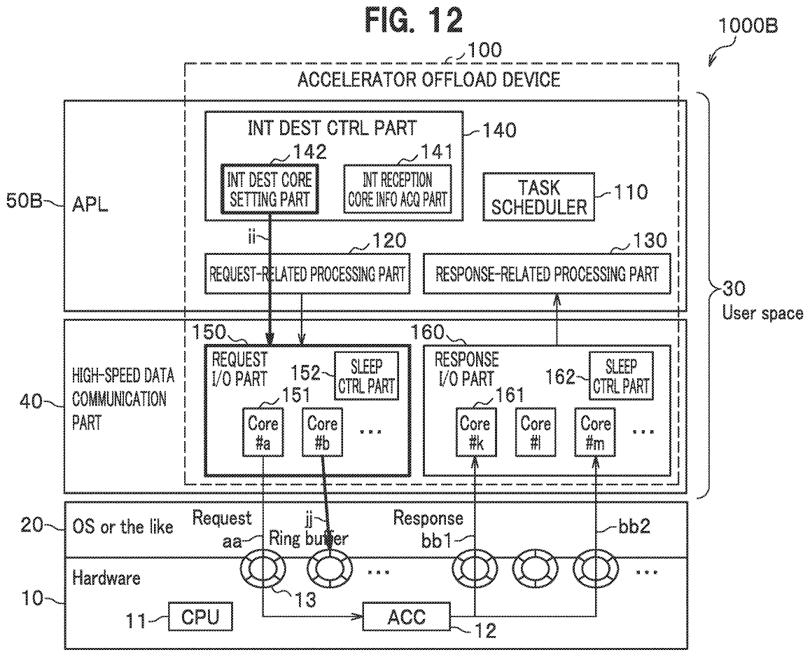

Interrupt destination core setting part 142 designates, at the time of requesting, a response destination to which ACC 12 returns the response (described later in FIG. 12).

### Series of Processing Required Before ACC Offloading>The series of processing required before ACC offloading will be described.

A description will be given taking an example where encoding processing of FEC in a vRAN or virtual DU (vDU) is offloaded to ACC 12.

### Uplink Processing

Request-related processing part 120 performs processing including mapping, equivalent processing, inverse discrete Fourier transform (IDFT), channel estimation, demodulation, and descrambling in resource elements.

Response-related processing part 130 performs frame processing (transmission processing of an Ethernet frame or the like).

### Downlink Processing

Request-related processing part 120 performs frame processing (reception processing of an Ethernet frame or the like).

Response-related processing part 130 performs processing including scrambling, modulation, layer mapping, precoding, and resource element mapping.

### Request I/O part 150

Request I/O part 150 has a plurality of CPU cores (core #a, core #b, . . . ) 151, and a sleep control part 152. Note that when CPU cores (core #a, core #b, . . . ) 151 are generically referred, they are denoted CPU core (core #n) 151.

Request I/O part 150 has CPU core (core #n) 151. CPU core (core #n) 151 performs request processing of notifying ACC 12 of an offload request.

Request I/O part 150 notifies ACC 12 of an offload request. At this time, request I/O part 150 copies via ring buffer 13 a workload to be processed.

When there is no task to be operated on the CPU, sleep control part 152 causes the thread(s) operating on the CPU to sleep.

In the following description, “sleep” means that the CPU executes a command having a small number of cycles, such as a pause command. In addition, when the CPU operating frequency of the CPU core being used by each processing part has lowered, sleep control part 152 increases the CPU operating frequency, and when the CPU idle state is in the power saving mode, sleep control part 152 causes a transition to the non-power saving mode.

### Response I/O Part 160

Response I/O part 160 includes: a plurality of CPU cores (core #k, core #l, . . . ) 161 different from CPU core (core #n) 151; and a sleep control part 162. Note when CPU cores (core #k, core #l, . . . ) 161 are generically referred, they are denoted CPU core (core #m) 161.

CPU core (core #m) 161 performs response processing of notifying response-related processing part 130 of operation completion of the accelerator.

Response I/O part 160 wakes up (starts) upon receipt of an interrupt. At this time, when the CPU operating frequency of CPU core (core #m) used by response I/O part 160 has lowered, task scheduler 110 increases the CPU operating frequency, and, when the CPU idle state is in the power saving mode, task scheduler 110 causes a transition to the non-power saving mode.

Response I/O part 160 notifies response-related processing part 130 that ACC 12 has completed the operation to communicate pointer information on an area of the ring buffer 13 where the operation result is stored.

When no task is to be operated on the CPU, sleep control part 162 causes the thread(s) operating on the CPU to sleep. In addition, when the CPU operating frequency of the CPU core being used by each processing part has lowered, sleep control part 162 increases the CPU operating frequency, and when the CPU idle state is in the power saving mode, sleep control part 162 causes a transition to the non-power saving mode.

### High-Speed Data Communication Part 40

High-speed data communication part 40 is a high-speed data communication layer configured with CUDA, OpenCL BBDEV API, and the like. For example, high-speed data communication part 40 is CUDA Toolkit (registered trademark) for using a GPU manufactured by NVIDIA (registered trademark) or OpenCL (registered trademark) for operation using a heterogeneous processor. In addition, BBDEV API (registered trademark) provides an accelerator I/O function for processing wireless access signals as a development kit (library).

High-speed data communication part 40 incorporates the accelerator I/O function provided as libraries by above-described CUDA, OpenCL, BBDEV API, or the like into APL 50 in user space 30, thereby allowing APL 50 to have the accelerator I/O function for processing wireless access signals.

Hereinafter, a description will be given of an operation of accelerator offload device 100 of the accelerator offload system 1000 configured as described above.

### Description of Principle

### (1) Interrupt Overhead Reduction (Reduction of Contention Between Application Processing and Interrupt Processing)

The present invention uses CPU cores separate for request processing and for response processing in order to avoid the interrupt overhead caused by the save processing in the interrupt method and parallelizes the request processing and the response processing. In the present embodiment, accelerator offload device 100 includes a CPU core for request processing (request-related processing part 120 and request I/O part 150) and a CPU core for response processing (response-related processing part 130 and response I/O part 160). In other words, accelerator offload device 100 provides (allocates) at least one of a plurality of CPU cores as a CPU core that is a response-dedicated functional part (response-related processing part 130 and response I/O part 160).

The CPU core for the response processing (functional part dedicated to the response) is provided and the request processing and the response processing are parallelized in order to prevent contention between the application processing and the interrupt processing, thereby achieving low latency. That is, a state in which there is no in-progress processing is maintained at the time of the interrupt to eliminate the save processing, thereby achieving low latency.

### (2) Reduction of Contention Between Interrupt Processes

In the present invention, the software dynamically sets an interrupt destination of the accelerator based on a processing state. Low latency is achieved by reducing the contention between interrupt processes.

### (3) Power Saving

In order to reduce an increase in the power consumption due to parallelization (increase in the power consumption caused by provision of the response-dedicated functional part), the present invention performs sleep control (including CPU operating frequency control and CPU idle state control) while there is no processing.

When there is no processing, sleep is performed and the CPU operating frequency and the CPU idle state are controlled to reduce power consumption to achieve further power saving.

### Overview of Operation of Accelerator Offload Device 100

As illustrated in FIG. 1, APL 50 requests request-related processing part 120 of accelerator offload device 100 to offload processing. Request-related processing part 120 performs series of processing required before ACC offloading and then notifies request I/O part 150 of a request to perform ACC offloading. CPU core (core #a) 151 of request I/O part 150 notifies ACC 12 of an offload request (see reference sign aa in FIG. 1). At this time, request I/O part 150 copies via a ring buffer 13 a workload to be processed.

ACC 12 operates the offloaded workload, then notifies, by a hardware interrupt, response I/O part 160 that the operation has been completed (see reference signs bb1, bb2 in FIG. 1) and stores the operation result in a ring buffer 13. At this time, as the destination of the hardware interrupt, a CPU core (CPU core (core #k) 161 or CPU core (core #m) 161 of response I/O part 160), which is different from CPU core (CPU core (core #n) 151 of request I/O part 150) used by request-related processing part 120, is designated.

A CPU core different from the CPU core used by request-related processing part 120 is designated as the destination of the hardware interrupt to parallelize the request processing and the response processing. As the contention between the application processing and the interrupt processing does not occur, low latency is achieved.

In addition, interrupt destination core setting part 142 of interrupt destination control part 140 of the APL 50 dynamically sets the interrupt destination of the accelerator based on the processing state. Here, interrupt destination core setting part 142 sets CPU core (core #k) 161 or CPU core (core #m) 161 of response I/O part 160 to ACC 12 as the hardware interrupt destination via a ring buffer 13.

ACC 12 notifies, by the hardware interrupt (see reference signs bb1 and bb2 in FIG. 1), either CPU core (core #k) 161 or CPU core (core #m) 161 of response I/O part 160 that the workload operation has been completed. Low latency is achieved by reducing the contention between interrupt processes.

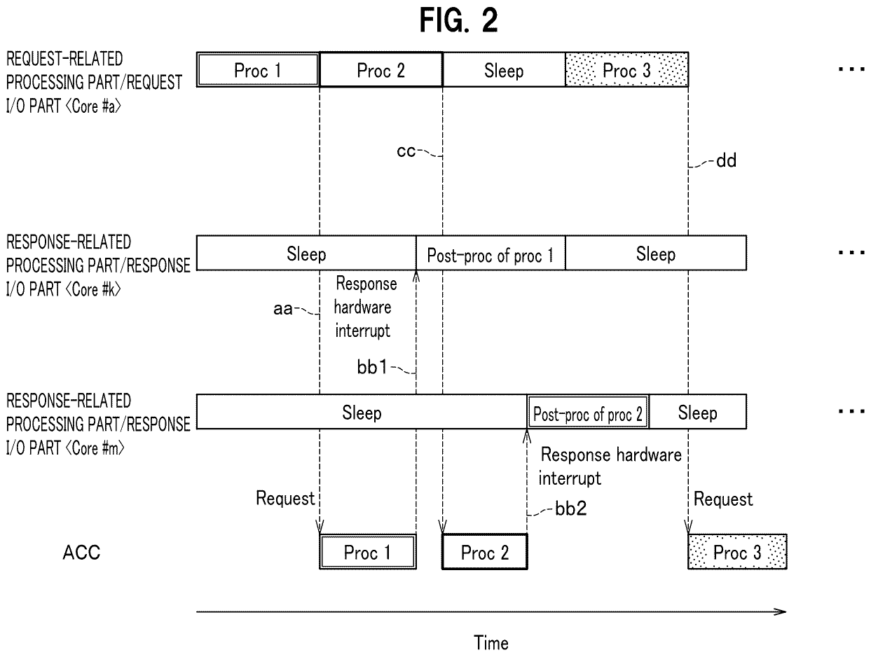

Hereinbelow, a detailed description will be given with reference to the schematic time-lapse diagram of FIG. 2.

FIG. 2 is a schematic time-lapse diagram illustrating an overview of an operation of accelerator offload device 100 illustrated in FIG. 1.

### Offload of Processing 1

As illustrated in FIG. 2, CPU core (core #a) 151 of request-related processing part 120 and request I/O part 150 requests ACC 12 to offload processing 1 being performed by an application thread (CPU) (see reference sign aa in FIG. 2). The application thread (CPU) is able to perform other processing (here, processing 2) during the ACC offloading. As the other processing is able to be performed while offloading to ACC 12 is being performed, high CPU utilization efficiency, which is the advantage of the conventional (1) interrupt method, will be enjoyed.

At this time, as CPU core (core #k) 161 of response-related processing part 130 and response I/O part 160 has no processing to perform (is not involved in the request-related processing), sleep control (including CPU operating frequency control and CPU idle state control) is performed while there is no processing. By performing sleep control (including CPU operating frequency control and CPU idle state control), power saving is achieved.

Here, interrupt destination core setting part 142 sets CPU core (core #k) 161 of response I/O part 160 to ACC 12 as the hardware interrupt destination via a ring buffer 13. ACC 12 operates the offloaded workload and notifies, by a hardware interrupt (see reference sign bbl in FIG. 2), CPU core (core #k) 161 of response I/O part 160 that the operation has been completed. That is, by the interrupt, CPU core (core #k) 161 of response I/O part 160, a CPU core for response processing (response-dedicated functional part), detects the completion of the operation by ACC 12.

CPU core (core #k) 161 of response-related processing part 130 and response I/O part 160 wakes up by the hardware interrupt. Response-related processing part 130 and response I/O part 160 perform post-processing of the processing 1 by the interrupt without suspending the in-progress processing (processing 2) (because request-related processing part 120 and request I/O part 150 are exclusively performing that processing) and perform sleep control after the post-processing of the processing 1.

The reason why response-related processing part 130 and response I/O part 160 are able to immediately perform the post-processing of the processing 1 by the interrupt is that CPU core (core #a) 151 of request-related processing part 120 and request I/O part 150 exclusively finishes the processing 2. CPU core (core #k) 161 of response-related processing part 130 and response I/O part 160 perform sleep control until waking up by the next hardware interrupt.

As the in-progress processing is not suspended by an interrupt and there is no need of saving intermediate data (concern of the conventional (1) interrupt method), it is possible to reduce the interrupt overhead by avoiding the save processing.

At this time, as CPU core (core #a) 151 of request-related processing part 120 and request I/O part 150 is not involved in the response-related processing (the processing is exclusively performed by response-related processing part 130 and response I/O part 160), the application thread (CPU) is able to request ACC 12 to offload the next processing (processing 2) (see reference sign cc in FIG. 2). The application thread (CPU) is able to perform other processing during ACC offloading. However, in this case, as there is no processing, sleep control is performed on the application thread. CPU core (core #a) 151 of request-related processing part 120 and request I/O part 150 achieves power saving by performing sleep control.

The reason why the in-progress processing is not suspended by the interrupt is that the response-related processing is exclusively performed by response-related processing part 130 and response I/O part 160 and the resources therefor are allocated to request-related processing part 120 and request I/O part 150, thereby increasing the efficiency of request-related processing part 120 and request I/O part 150.

### Offload of Processing 2

As illustrated in FIG. 2, CPU core (core #a) 151 of request-related processing part 120 and request I/O part 150 requests ACC 12 to offload processing 1 being performed by the application thread (CPU) (see reference sign cc in FIG. 2).

Here, interrupt destination core setting part 142 sets CPU core (core #m) 161 of response I/O part 160 to ACC 12 as the hardware interrupt destination via a ring buffer 13. ACC 12 operates the offloaded workload and notifies, by a hardware interrupt (see reference sign bb2 in FIG. 2), CPU core (core #m) 161 of response I/O part 160 that the operation has been completed. That is, by the interrupt, CPU core (core #m) 161 of response I/O part 160, a CPU core for response processing (response-dedicated functional part), detects the completion of the operation by ACC 12.

CPU core (core #m) 161 of response-related processing part 130 and response I/O part 160 wakes up by the hardware interrupt. CPU core (core #m) 161 of response-related processing part 130 and response I/O part 160 performs post-processing of the processing 2 by the interrupt. Response-related processing part 130 and response I/O part 160 perform post-processing of the processing 2 by the interrupt without suspending the in-progress processing (processing 2) (because request-related processing part 120 and request I/O part 150 are exclusively performing that processing) and perform sleep control after the post-processing of the processing 2. CPU core (core #k) 161 of response-related processing part 130 and response I/O part 160 performs sleep control until waking up by the next hardware interrupt.

At this time, as CPU core (core #a) 151 of request-related processing part 120 and request I/O part 150 is not involved in the response-related processing (the processing is exclusively performed by response-related processing part 130 and response I/O part 160), the application thread (CPU) is able to request ACC 12 to offload the next processing (processing 3) (see reference sign dd in FIG. 2). The application thread (CPU) is able to perform other processing during ACC offloading. However, in this case, as there is no processing, sleep control is performed on the application thread.

In the same way hereinafter, CPU core (core #a) 151 of request-related processing part 120 and request I/O part 150 requests ACC 12 to offload processing 3 being performed by the application thread (CPU) (see reference sign dd in FIG. 2).

### Summary

As can be seen from the schematic time-lapse diagram of FIG. 2, the present invention has the following features.
(1) As the request processing and the response processing are parallelized, the request processing and the response processing do not contend with each other (Feature <1>).
(2) As interrupt destination core setting part 142 of interrupt destination control part 140 of the APL 50 dynamically sets the interrupt destination of ACC 12, the response processes do not contend with one another (Feature <2>).
(3) As the sleep control parts 152 and 162 perform sleep control (including CPU operating frequency control and CPU idle state control) while there is no processing, power saving can be achieved by performing the sleep while there is no processing (Feature <3>).

### Flowchart

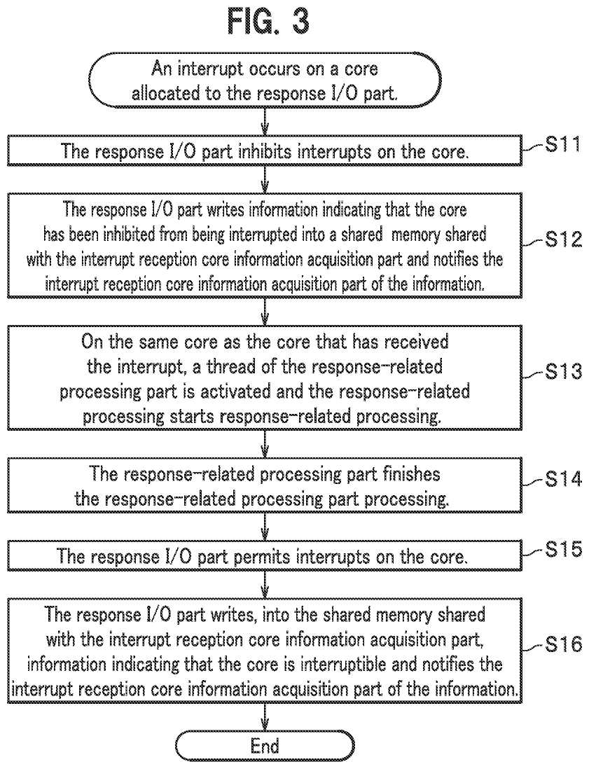

An operation of accelerator offload device 100 will be described with reference to the flowcharts illustrated in FIGS. 3 to 8.

### Operation Flow of Response I/O Part 160 and Response-Related Processing Part 130

FIG. 3 is a flowchart illustrating an operation of response I/O part 160 and response-related processing part 130 of the accelerator offload device 100.

This flow starts when an interrupt occurs on a core allocated to response I/O part 160 (FIG. 1).

In step S11, response I/O part 160 of the accelerator offload device 100 inhibits interrupts on the core.

In step S12, response I/O part 160 writes information indicating that the core has been inhibited from being interrupted into a shared memory 143 shared with interrupt reception core information acquisition part 141 and notifies interrupt reception core information acquisition part 141 of the information.

In step S13, on the same core as the core which has received the interrupt, a thread of response-related processing part 130 is activated to start response-related processing.

In step S14, response-related processing part 130 finishes the response-related processing.

In step S15, response I/O part 160 permits interrupts on the core.

In step S16, response I/O part 160 writes, into the shared memory 143 shared with interrupt reception core information acquisition part 141, information indicating that the core is interruptible, notifies interrupt reception core information acquisition part 141 of the information, and finishes the processing of the present flow.

### Operation Flow in which Interrupt Destination Core Setting Part 142 Sets Interrupt Destination Core to ACC 12 and Interrupt is Raised Actually

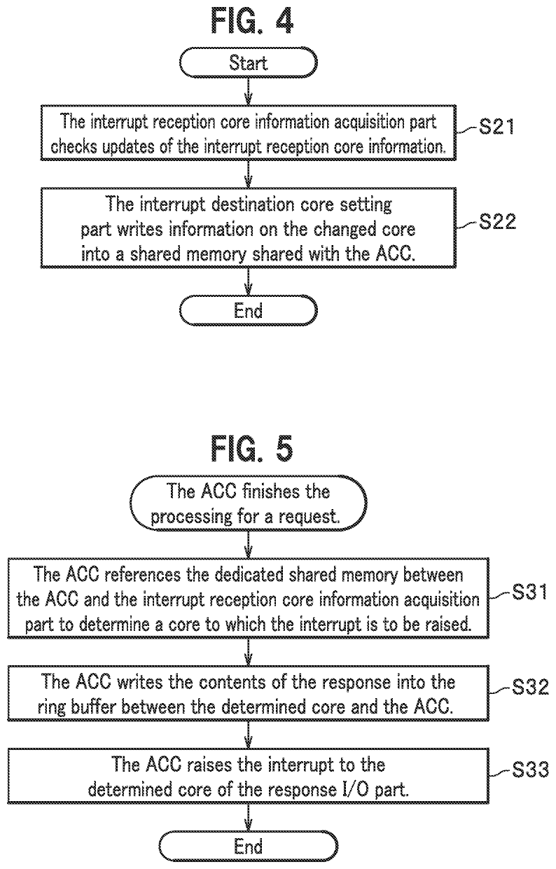

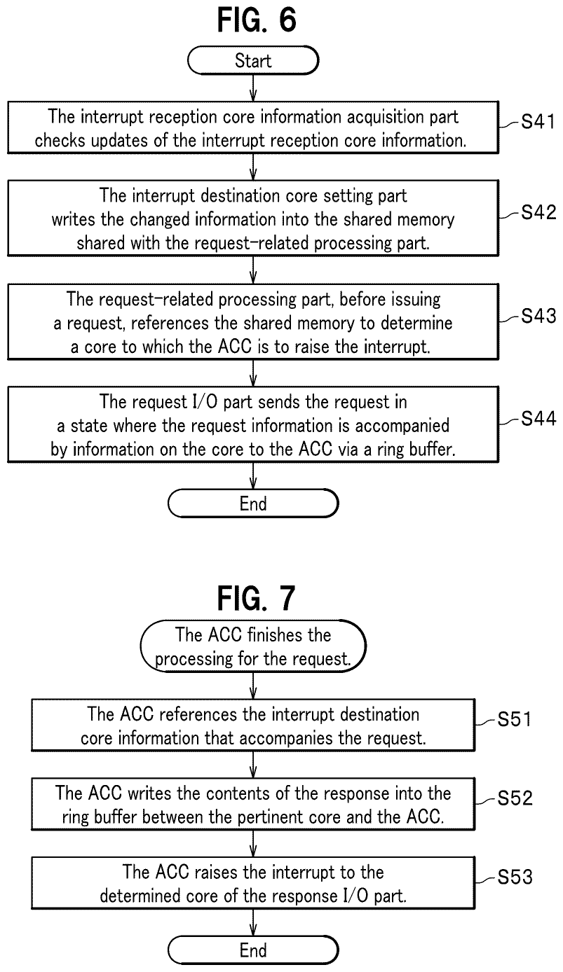

An operation flow in which interrupt destination core setting part 142 sets an interrupt destination core to ACC 12 and an interrupt is actually raised is classified into: an operation flow (FIGS. 4 and 5) and an operation block diagram (FIG. 11) of a case where a dedicated shared memory 143 is provided between interrupt destination core setting part 142 and ACC 12; and an operation flow (FIGS. 6 and 7) and an operation block diagram (FIG. 12) of a case where information on the core to which the response is to be raised is included in the request (a case where the shared memory 143 is not provided). Description thereof will be given in order.

FIG. 4 is a flowchart illustrating the operation of, when providing a dedicated shared memory 143 between interrupt destination core setting part 142 and ACC 12, setting the interrupt destination core to ACC 12 by interrupt destination core setting part 142.

In step S21, interrupt reception core information acquisition part 141 checks updates of the interrupt reception core information.

In step S22, interrupt destination core setting part 142 writes information on the changed core into a shared memory 143 shared with ACC 12 and finishes the processing of the present flow.

FIG. 5 is a flowchart illustrating the operation of, when providing a dedicated shared memory 143 between interrupt destination core setting part 142 and ACC 12, raising an interrupt by ACC 12.

The present flow starts when ACC 12 finishes the processing for a request.

In step S31, ACC 12 references the dedicated shared memory 143 provided between ACC 12 and interrupt reception core information acquisition part 141 to determine a core to which the interrupt is to be raised.

In step S32, ACC 12 writes the contents of the response into the ring buffer 13 between the determined core and ACC 12.

In step S33, ACC 12 raises the interrupt to the determined core of response I/O part 160 and finishes the processing of the present flow.

FIG. 6 is a flowchart illustrating an operation of, when configuring the request to include information on the core to which the response is to be raised, setting an interrupt destination core to ACC 12 by interrupt destination core setting part 142.

In step S41, interrupt reception core information acquisition part 141 checks updates of the interrupt reception core information.

In step S42, interrupt destination core setting part 142 writes the changed information into a shared memory 143 shared with request-related processing part 120.

In step S43, before issuing a request, request-related processing part 120 references the shared memory 143 to determine a core to which ACC 12 is to raise the interrupt.

In step S44, request I/O part 150 sends the request in a state where the request information is accompanied by information on the core to ACC 12 via a ring buffer 13 and finishes the processing of the present flow.

FIG. 7 is a flowchart illustrating the operation of, when configuring the request to include information on the core to which the response is to be raised, raising an interrupt by ACC 12.

The present flow starts when ACC 12 finishes the processing for the request.

In step S51, ACC 12 references the dedicated shared memory 143 provided between ACC 12 and interrupt reception core information acquisition part 141 to determine a core to which the interrupt is to be raised.

In step S52, ACC 12 writes the contents of the response into the ring buffer 13 between the determined core and ACC 12.

In step S53, ACC 12 raises the interrupt to the determined core of response I/O part 160 and finishes the processing of the present flow.

### Operation Flow of Request I/O Part 150 and Request-Related Processing Part 120

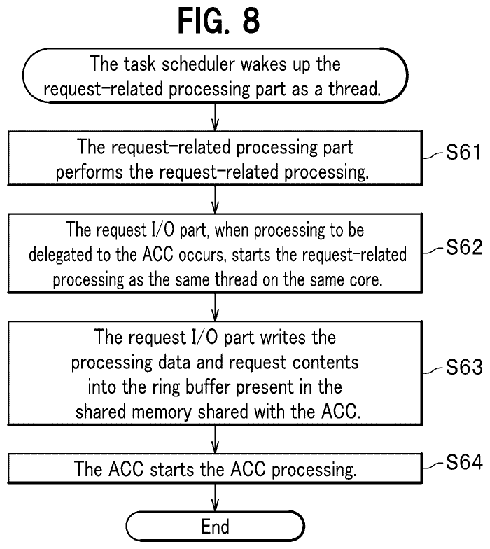

FIG. 8 is a flowchart illustrating the operations of request I/O part 150 and request-related processing part 120.

The present flow starts when task scheduler 110 (FIG. 1) wakes up request-related processing part 120 as a thread.

In step S61, request-related processing part 120 performs the request-related processing. In step S62, when processing to be delegated to ACC 12 occurs, request I/O part 150 starts the request-related processing as the same thread on the same core.

In step S63, request I/O part 150 writes the processing data and request contents into the ring buffer 13 present in the shared memory 143 shared with ACC 12.

In step S64, ACC 12 starts processing and finishes the processing of the present flow.

Hereinbelow, description will be given of an operation of accelerator offload device 100 of accelerator offload system 1000 configured as described above.

### Parallelization of Request and Response (Feature <1>)

The parallelization of request and response (Feature <1>) will be described.

The parallelization of request and response (Feature <1>) parallelizes the request processing and the response processing to avoid the interrupt overhead due to the save processing in the interrupt method thereby to eliminate the contention between the application processing and the interrupt processing, achieving low latency.

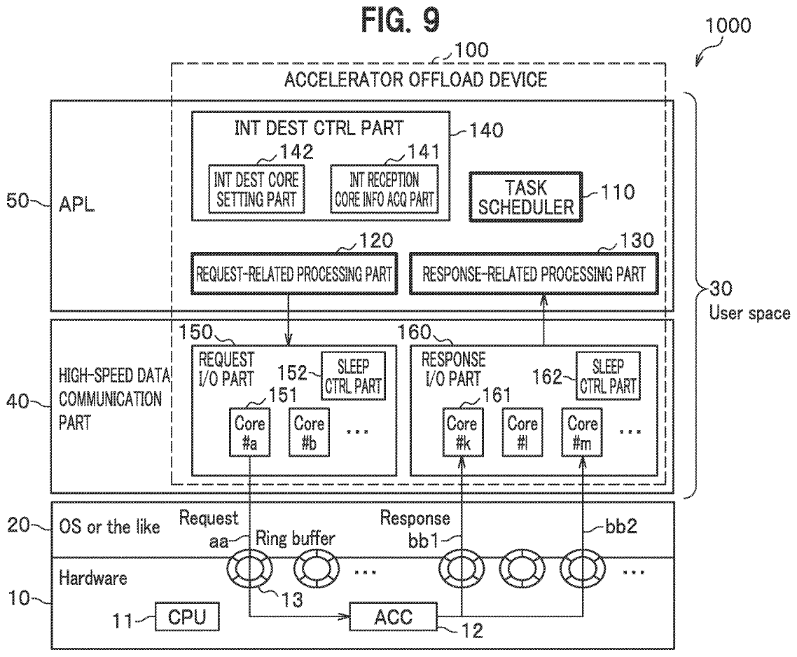

FIG. 9 is an operation explanatory diagram of the accelerator offload system, for explaining the parallelization of request and response (Feature <1>). The same components as those in FIG. 1 are denoted by the same reference signs. The functional parts relevant to the operations described in the following description are represented by thick frames.

As illustrated in FIG. 9, task scheduler 110 allocates cores (core #a, b, . . . ) for request-related processing part 120 and request I/O part 150 and cores (core #k, l, m, . . . ) for response-related processing part 130 and response I/O part 160 separately from each other. That is, task scheduler 110 separates the cores (core #a, b, . . . ) for performing processing of sending a request to ACC 12 and the cores (core #k, l, m, . . . ) for performing processing of receiving a response from ACC 12 to prevent the occurrence of processing contention.

### Basic Operation of Request-related Processing Part 120

A description will be given of a basic operation of request-related processing part 120 in the parallelization of request and response.

The request-related processing part 120 performs the application processing and delegates part of the processing to ACC 12. The above-described delegation is performed by request I/O part 150. The data of request is transmitted through the ring buffer 13 provided in the shared memory 143 shared with ACC 12. Here, no response is returned to the core allocated for the request.

A core allocated to response I/O part 160 and response-related processing part 130 receives an interrupt that signals the completion of operation from ACC 12.

The data of the response is written into the ring buffer 13 provided in the shared memory 143 (see FIG. 11) shared with ACC 12, and on the interrupted core, response I/O part 160 receives the data of the response and continues the response-related processing.

On the core allocated for the response, no other application processing will run, so that the contention won't occur. However, this function alone may possibly cause a contention between response processes, so the Feature <2> described below is required.

### Dynamic Setting of Interrupt Destination of ACC 12 According to Processing State (Feature <2>)

A description will be given of the dynamic setting of the interrupt destination (Feature <2>) of ACC 12 according to the processing state.

The dynamic setting (Feature <2>) of the interrupt destination of ACC 12 according to the processing state achieves low latency by preventing the contention between interrupt processes in the response processing by dynamically setting the interrupt destination of ACC 12 according to the processing state.

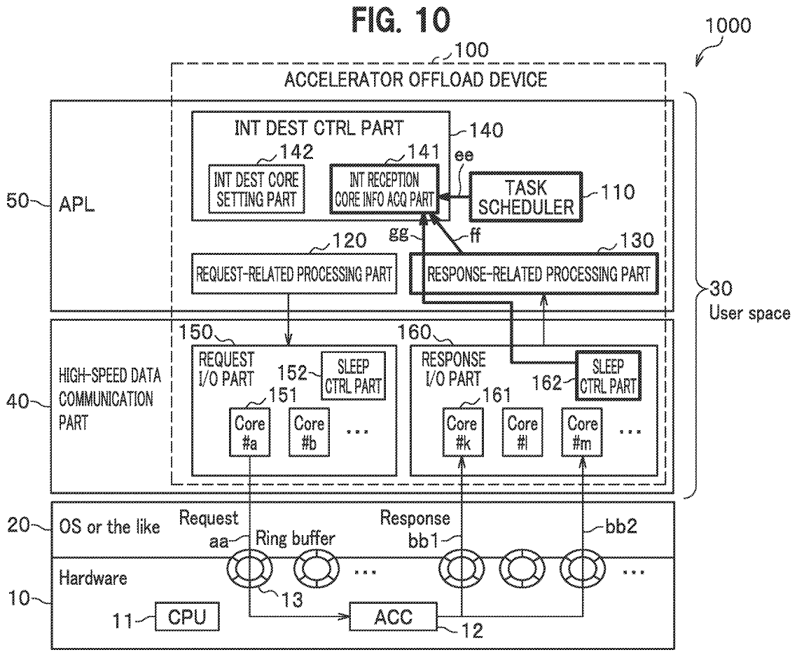

The operation of dynamic setting of the interrupt destination of ACC 12 (Feature <2>) according to the processing state is classified into: an operation (Feature <2-1>) (FIG. 10) of interrupt reception core information acquisition part 141; and an operation (Feature <2-2>) (FIG. 11) of interrupt destination core setting part 142.

### Basic Operation of Interrupt Reception Core Information Acquisition Part 141

First, description will be given of the basic operation of interrupt reception core information acquisition part 141 in the dynamic setting of the interrupt destination of ACC 12 according to the processing state.

The operation (Feature <2-1>) of interrupt reception core information acquisition part 141 manages information on the cores in charge of response-related processing part 130 and acquires information on cores among them which are able to be immediately activated by an interrupt notification. Interrupt reception core information acquisition part 141 notifies interrupt destination core setting part 142 of the acquired information.

FIG. 10 is an operation (Feature <2-1>) explanatory diagram of interrupt reception core information acquisition part 141 for dynamically setting the interrupt destination of ACC 12 according to the processing state. The same components as those in FIG. 1 are denoted by the same reference signs.

As illustrated in FIG. 10, interrupt reception core information acquisition part 141 acquires the cores allocated for response from task scheduler 110 (see reference sign ee in FIG. 10). Among them, a core in sleep is an interrupt-receivable core.

When response I/O part 160 receives an interrupt, interrupt reception core information acquisition part 141 updates the information so as to indicate that the pertinent core is uninterruptible (see reference sign ff in FIG. 10).

When the response-related processing is finished and sleep is performed, interrupt reception core information acquisition part 141 updates the information so as to indicate that the pertinent core is interruptible (see reference sign gg in FIG. 10).

### Basic Operation of Interrupt Destination Core Setting Part 142

Next, description will be given of a basic operation of interrupt destination core setting part 142 in the dynamic setting of the interrupt destination of ACC 12 according to the processing state.

The operation (Feature <2-2>) of interrupt destination core setting part 142 sets a core to which ACC 12 is to raise an interrupt based on the interrupt reception core information when finishing the processing.

### Interrupt Destination Core Setting Method

The interrupt destination core setting method includes: (1) a method with a dedicated shared memory 143 shared with ACC 12 (see FIG. 11); and (2) a method in which the response destination is designated at the time of requesting (see FIG. 12). Description thereof will be given in order.

FIG. 11 is an operation (Feature <2-2>) explanatory diagram of interrupt destination core setting part 142 by the method with a dedicated shared memory 143 shared with ACC 12.

The same components as those in FIG. 1 are denoted by the same reference signs, and description of duplicated portions is omitted.

As illustrated in FIG. 11, in an accelerator offload system 1000A, a dedicated shared memory 143 is provided on the hardware (HW) 10 between interrupt destination core setting part 142 and ACC 12.

Interrupt destination core setting part 142 stores information on the cores currently interruptible in a shared memory 143 for the interrupt destination core information (see reference sign hh in FIG. 11). ACC 12 references this shared memory 143 before (just before) raising a response, to return the response to an free core.

With this, interrupt destination core setting part 142 is able to directly write the core information into the shared memory 143 on hardware 10 without passing through request I/O part 150 of high-speed data communication part 40 composed of middleware.

FIG. 12 is an operation (Feature <2-2>) explanatory diagram of interrupt destination core setting part 142 by the method in which the response destination is designated at the time of requesting. The same components as those in FIG. 1 and FIG. 11 are denoted by the same reference signs, and description of the duplicated portions will be omitted.

As illustrated in FIG. 12, an accelerator offload system 1000B has shared memory (not illustrated) between interrupt destination core setting part 142, ACC 12 and request I/O part 150. This shared memory is a shared memory for high-speed data transfer with the application program.

Interrupt destination core setting part 142 has a shared memory (not illustrated) shared with request I/O part 150 and stores therein information on the cores currently interruptible (see reference sign ii in FIG. 12). Request I/O part 150 references the shared memory (not illustrated) before issuing a request and imparts pertinent information to the request data (see reference sign jj in FIG. 12). ACC 12, based on this information, returns the operation result of the request to the designated core for the response.

With this, interrupt destination core setting part 142 diverts the shared memory to store the information on the cores currently interruptible. This is advantageous in that it is not necessary to provide dedicated shared memory 143 () between interrupt destination core setting part 142 and ACC 12.

### Sleep Control for Performing Sleep While There is No Processing (Feature <3>)

Next, description will be given of sleep control (including CPU operating frequency control and CPU idle state control) (Feature <3>) for performing sleep while there is no processing.

For the sleep control (Feature <3>), the CPU performs the sleep control (including CPU operating frequency control and CPU idle state control) during the time when there is no request or no response.

At this time, the operation frequency is set to the minimum before the sleep, and the operation frequency is returned to the maximum after the sleep.

### Basic Operation of Sleep Control

The basic operation of the sleep control is classified into request processing and response processing. Description thereof will be given in order.

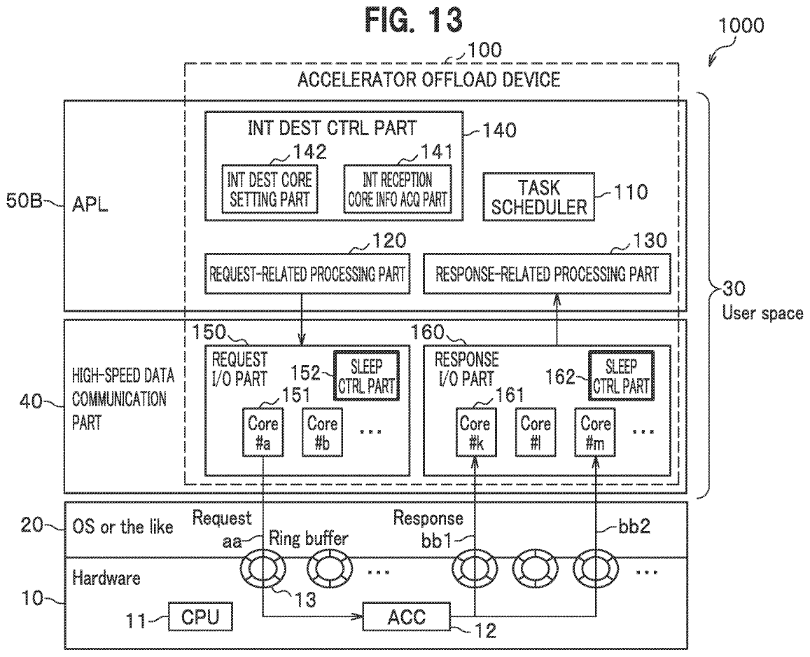

FIG. 13 is an operation (Feature <3>) explanatory diagram of the sleep control. The same components as those in FIG. 1 are denoted by the same reference signs, and description of duplicating portions is omitted.

Note that the operation of the sleep control (Feature <3>) applied to the accelerator offload system 1000 in FIG. 1 will be described as an example and that it can be applied to the accelerator offload system 1000A in FIG. 11 and the accelerator offload system 1000B in FIG. 12 in the same manner.

### Request Processing

As illustrated in FIG. 13, when the request-related processing given from task scheduler 110 and the request I/O processing generated therefrom are finished, the processing enters sleep. Then, sleep control part 152 of request I/O part 150 lowers the operation frequency (for example, lowers the operating frequency to the minimum). When processing is newly given from task scheduler 110, sleep control part 152 releases sleep and raises the operation frequency to the maximum.

### Response Processing

As illustrated in FIG. 13, when the response I/O processing started upon reception of an interrupt from ACC 12 and the subsequent Response-related processing are finished, the processing enters sleep. Then, sleep control part 162 of response I/O part 160 lowers the operation frequency to the minimum. When an interrupt is newly raised from ACC 12, sleep control part 162 raises the operation frequency (for example, raises the operation frequency to the maximum).

### Operations of Accelerator Offload Device 100 of Accelerator Offload System 1000

Operations of the accelerator offload device 100 of an accelerator offload system 1000C will be described.

The operations of the accelerator offload device 100 is classified into: <preparation stage before the application actually processes data: core allocation>, <acquisition of information on whether each core of request I/O part 150 is “currently” capable of receiving an interrupt>, <until an interrupt destination core is set to the ACC and the interrupt is raised to the set core>, <from the start to the end of the processing of request-related processing part 120 and request I/O part 150>, and <from the start to the end of the processing of response-related processing part 130 and response I/O part 160>. Description thereof will be given in order.

### Preparation Stage Before Application Actually Processes Data: Core Allocation>

### 1

As illustrated in FIG. 13, task scheduler 110 allocates, of the available CPU cores provided from the OS, a part to the request-related processing, a part to the response-related processing, and a part to interrupt destination control part 140. For example, in FIG. 13, core #a, core #b, . . . are allocated to request-related processing part 120 and request I/O part 150, and core #k, core #l, and core #m are allocated to response-related processing part 130 and response I/O part 160.

Although not illustrated in FIG. 13, in the present embodiment, one or two CPU cores are also allocated to interrupt destination control part 140. One CPU core is allocated to each of interrupt reception core information acquisition part 141 and interrupt destination core setting part 142, or one CPU core in total is allocated to them.

### 2

Interrupt reception core information acquisition part 141 receives, from task scheduler 110, information on the core numbers allocated to response-related processing part 130.

Alternatively, this information may be received from response-related processing part 130. As a method of reception, communication by inter-process communication and communication using a shared memory 143 are conceivable.

### 3

The shared memory 143 (FIG. 11) is provided between interrupt destination control part 140 and response I/O part 160, and the core numbers allocated to response-related processing part 130 are stored in the shared memory 143.

The above described (1) to (3) are performed when a core is newly provided to the application from the OS even during the execution of the application. That is, when a core is newly provided, task scheduler 110 allocates the core to the request-related processing or the response-related processing. When there is a core newly allocated to the response-related processing, information is given to interrupt reception core information acquisition part 141 from task scheduler 110 or response-related processing part 130. Based on the given information, interrupt destination control part 140 stores the information in the shared memory 143 (see FIG. 11) shared with response I/O part 160.

On the contrary, when the OS takes a core from the application, an operation reverse of the present procedure is performed. That is, task scheduler 110 reduces the cores of the request-related processing or the response-related processing by one. When a cores is reduced from the response-related processing, task scheduler 110 or response-related processing part 130 notifies interrupt reception core information acquisition part 141 of the reduction. Based on this information, interrupt destination control part 140 deletes the information on the pertinent core from the shared memory 143 shared with response I/O part 160.

### Until Interrupt Reception Core Information Acquisition Part 141 Acquires Information on Whether Each Core of Response I/O Part 160 Is “Currently” Capable of Receiving Interrupt

Premise 1: As described as Feature <3>, a core allocated to response I/O part 160 performs sleep when no processing is occurring, and in this state, is “capable of receiving an interrupt”. This is because contention with other processing does not occur even if an interrupt occurs and thus low latency is kept. At the stage where the application processing starts, all the cores allocated to response I/O part 160 are in an interrupt receivable state.

Premise 2: When a core allocated to response I/O part 160 does not perform sleep, the core is “incapable of receiving an interrupt”. This is because an interrupt occurring in this state invariably causes processing contention and low latency is compromised.

### When Interrupt Reception Cores are Reduced

The procedure in the case where the interrupt reception cores are reduced is started when an interrupt occurs on a core allocated to response I/O part 160 and thus the “interrupt-receivable cores” are reduced.

### 1

Response I/O part 160, when receiving an interrupt from ACC 12, immediately inhibits interrupts on the pertinent core and releases the sleep.

### 2

The pertinent core of response I/O part 160 notifies interrupt reception core information acquisition part 141 of the information on the core for which interruption has been inhibited.

This is achieved by rewriting the “shared memory 143 provided between response I/O part 160 and interrupt destination control part 140” provided in the preparation stage.

Method 1: The information on the pertinent core is deleted from the “allocated core information” stored in the shared memory 143.

Method 2: A list of cores for which “interruption is currently inhibited” is created in the shared memory 143 and information on the pertinent core is described therein.

The difference between these methods is a difference in the data structure in the shared memory 143 and determination is made before operation.

### 3

Response I/O part 160 notifies interrupt destination control part 140 that the interrupt-receivable core information has been rewritten. For example, notification by eventfd, which is a file descriptor for event notification, and notification by inter-process communication are available.

### When Interrupt Reception Cores Are Increased

The procedure when the interrupt reception cores are increased is started when response-related processing part 130 finishes the processing and thus the “interrupt-receivable cores” are increased.

### 1

Response-related processing part 130, when the processing is finished, notifies interrupt destination control part 140 of information on the core whose processing is finished.

### 2

Interrupt reception core information acquisition part 141 adds the information on the pertinent core to the shared memory 143 between interrupt destination control part 140 and response I/O part 160.

Method 1: Information is appended to “allocated core information”.

Method 2: Information on the pertinent core is deleted from an “interrupt inhibition list”.

### Until interrupt destination core setting part 142 Sets Interrupt Destination Core to ACC and an Interrupt Is Raised to the Set Core

This procedure is started when a change occurs in the interrupt reception core information due to a change made to the allocation of cores by task scheduler 110 or when a change occurs in the interrupt reception core information due to starting/finishing response-related processing.

### 1

Interrupt reception core information acquisition part 141 checks which core is inhibited from being interrupted or permitted to be interrupted. Specifically, interrupt reception core information acquisition part 141 references the shared memory 143 between interrupt destination control part 140 and response-related processing part 130 to perform the checking.

Thereafter, the behavior of “interrupt destination core setting part 142” depends on the “method of setting interrupt destination core”.

### Setting Method 1: When Dedicated Shared Memory is Shared with ACC

### 1

When a dedicated shared memory 143 shared with ACC 12, a shared memory 143 for storing information on cores which are interruptible is provided separately from the ring buffer 13 used for exchanging the request and the response.

### 2

The information on the changed core is also written into the shared memory 143 shared with ACC 12. Specifically, the shared memory 143 is provided with an interrupt-receivable core list, and deletion and/or addition is performed therein.

### 3

ACC 12, after finishing the processing for a request, references the shared memory 143 to determine a interrupt-receivable core.

### 4

ACC 12 writes the response into the ring buffer 13 between the interrupt-receivable core and ACC 12 and raises an interrupt to the core.

### Setting Method 2: When Information on Core to Which Response is to be Raised is Included in Request

### 1

A method in which the destination to which the response is to be raised is determined at the time of requesting and that information is passed to ACC 12 together with the request. A shared memory (not illustrated) is provided between request-related processing part 120 and interrupt destination control part 140.

### 2

The shared memory (not illustrated) between request-related processing part 120 and interrupt destination control part 140 is provided with an interrupt-receivable core list, and deletion and/or addition are performed therein.

### 3

Request-related processing part 120, prior to causing request I/O part 150 to issue the request, references the interrupt-receivable core list.

### 4

One core is selected from the interrupt-receivable core list, and the request is sent to ACC 12 through the ring buffer 13 in a state that the request information is accompanied by the information on the core.

### 5

ACC 12 receives the request, executes the operation, then writes response information into the ring buffer 13 provided between the response core specified in the accompanying information and ACC 12, and raises an interrupt to the core.

### From Start to End of Processing of Response-Related Processing Part 130 and Response I/O Part 160

In the procedure from the start to the end of the core allocated to response-related processing part 130, as the coordination between response I/O part 160 and interrupt destination control part 140 has been already described, description thereof is omitted, and only the flow of data processing will be described.

### 1

ACC 12, upon finishing the operation, stores the processing result in the ring buffer 13 in the shared memory 143 shared with one core allocated to response I/O part 160 and raises an interrupt to the core.

### 2

Response I/O part 160 rises, and response I/O part 160 inhibits interrupts on the core.

### 3

Response I/O part 160 activates a thread of response-related processing part 130. Note that it runs on the same core as the core in which response I/O part 160 rises in response to the interrupt.

### 4

Response-related processing part 130 accesses the ring buffer 13 in the shared memory 143 shared between the core and ACC 12 and reads the operation result.

### 5

Response-related processing part 130 releases the inhibition of interrupts on the core and performs post-processing. This processing differs depending on the application.

### Second Embodiment

### Overall Configuration

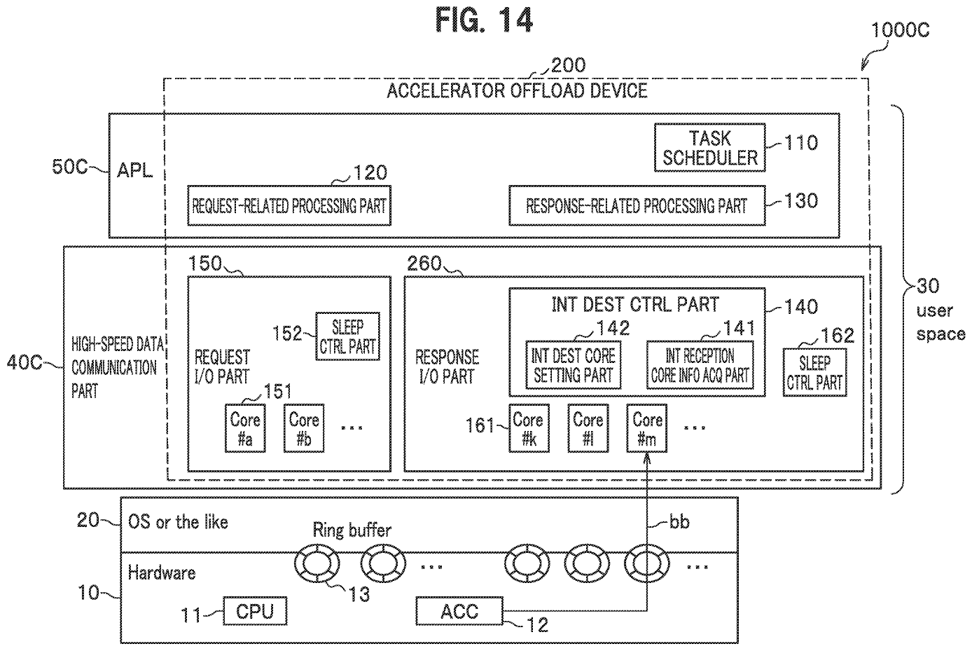

FIG. 14 is a schematic configuration diagram of an accelerator offload system according to a second embodiment of the present invention. The same components as those in FIG. 1 are denoted by the same reference signs, and the description of duplicating portions is omitted.

As illustrated in FIG. 14, an accelerator offload system 1000C includes hardware (HW) 10 and an OS or the like 20, as well as a high-speed data communication part 40C that is high-speed data transfer middleware deployed in a user space 30, an accelerator offload device 200, and an APL 50C.

### Accelerator Offload Device 200

Accelerator offload device 200 includes a task scheduler 110, a request-related processing part 120, a response-related processing part 130, an interrupt destination control part 140, a request I/O part 150, and a response I/O part 260.

Here, in accelerator offload device 200, task scheduler 110, request-related processing part 120, and response-related processing part 130 are included in APL 50C, and request I/O part 150 and response I/O part 260 are included in high-speed data communication part 40C. In addition, response I/O part 260 includes interrupt destination control part 140. That is, in accelerator offload device 200, interrupt destination control part 140 is included in response I/O part 260 of high-speed data communication part 40C.

Interrupt destination control part 140 of accelerator offload device 200 is provided in response I/O part 260 outside the application (APL) 50 (application program), and dynamically sets an interrupt destination CPU core of the accelerator according to an application processing state without delivering interrupt reception information from response I/O part 260 to the application program.

Hereinafter, an operation of accelerator offload device 200 of accelerator offload system 1000C configured as described above will be described.

### Flowchart

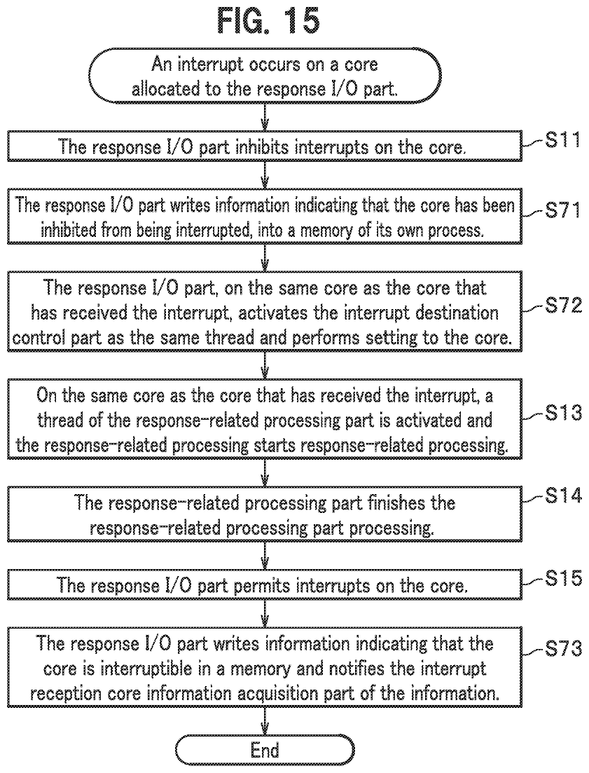

An operation of accelerator offload device 200 will be described with reference to the flowcharts illustrated in FIGS. 15 to 17.

### Operation Flow of Response I/O Part 260 and Response-Related Processing Part 130

FIG. 15 is a flowchart illustrating operations of response I/O part 260 and response-related processing part 130 of accelerator offload device 200. For the steps of performing the same processing as that in FIG. 3, the same step numbers are denoted and description thereof is omitted.

The present flow starts when an interrupt occurs on a core allocated to response I/O part 260 (FIG. 14).

In step S11, response I/O part 260 of the accelerator offload device 200 inhibits interrupts on the core.

In step S71, response I/O part 260 writes information indicating that the core has been inhibited from being interrupted, into a memory of its own process.

In step S72, response I/O part 260, on the same core as the core that has received the interrupt, activates interrupt destination control part 140 as the same thread and performs setting to the core.

In step S13, on the same core as the core that has received the interrupt, a thread of response-related processing part 130 is activated to start the response-related processing.

In step S14, response-related processing part 130 finishes the response-related processing.

In step S15, response I/O part 260 permits interrupts on the core.

In step S73, response I/O part 260 writes information indicating that the core is interruptible in a memory (e.g., the shared memory 143 in FIG. 11, shared with interrupt reception core information acquisition part 141), notifies interrupt reception core information acquisition part 141 of the information, and finishes the processing of the present flow.

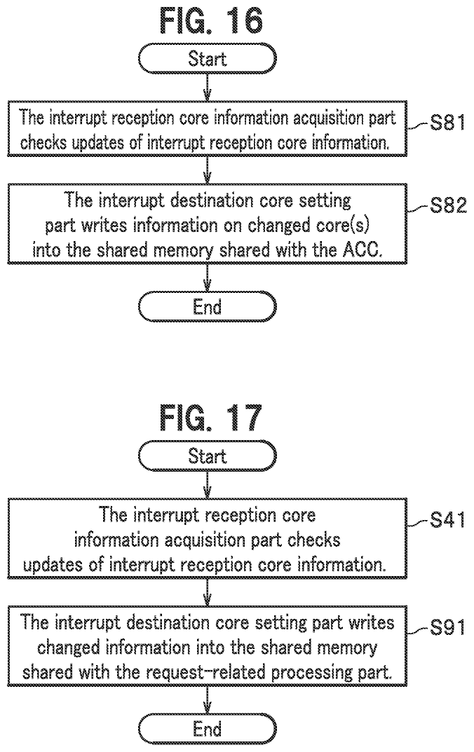

FIG. 16 is a flowchart illustrating an operation of, when providing a dedicated shared memory 143 between interrupt destination core setting part 142 and ACC 12, setting the interrupt destination core to ACC 12 by interrupt destination core setting part 142 of interrupt destination control part 140 of response I/O part 260.

In step S81, interrupt reception core information acquisition part 141 of interrupt destination control part 140 of response I/O part 260 checks updates of interrupt reception core information.

In step S82, interrupt destination core setting part 142 writes information on changed core(s) in the shared memory 143 shared with ACC 12 and finishes the processing of the present flow.

FIG. 17 is a flowchart illustrating an operation of, when configuring the request to include information on a core to which the response is to be raised, setting the interrupt destination core to ACC 12 by interrupt destination core setting part 142 of interrupt destination control part 140 of response I/O part 260. For the steps for performing the same processing as those in FIG. 6, the same step numbers are denoted and description thereof is omitted.

In step S41, interrupt reception core information acquisition part 141 of interrupt destination control part 140 of response I/O part 260 checks updates of interrupt reception core information.

In step S91, interrupt destination core setting part 142 writes changed information into the shared memory 143 shared with request-related processing part 120 and finishes the processing of the present flow.

### Features of Present Embodiment

The accelerator offload device 200 of the present embodiment includes interrupt destination control part 140 in response I/O part 260.

As it is possible to perform the interrupt destination control without delivering the interrupt reception information from response I/O part 260 to the application, it is advantageous in that the interrupt destination control is performed with high-speed and high efficiency.

In the present embodiment, the request/Response parallelization of Feature <1> and the sleep control of Feature <3> are the same as those in the first embodiment.

Features according to the present embodiment will be described.

Accelerator offload device 200 includes interrupt destination control part 140 in response I/O part 260, and interrupt reception core information acquisition part 141 has the following features.

### interrupt Reception Core Information Acquisition Part 141>

Interrupt reception core information acquisition part 141 illustrated in FIG. 14 manages information on the cores in charge of response-related processing part 130 and acquires information on the cores that is able to be immediately activated by an interrupt notification.

Interrupt reception core information acquisition part 141 notifies interrupt destination core setting part 142 of the acquired information.

### Basic Operation

Interrupt reception core information acquisition part 141 acquires, from task scheduler 110, information on the cores allocated for response. Among them, cores performing sleep are interrupt-receivable cores.

When response I/O part 260 receives an interrupt, interrupt reception core information acquisition part 141 updates the information so as to indicate that the pertinent core is uninterruptible.

When the response-related processing finishes and perform sleep, interrupt reception core information acquisition part 141 updates the information so as to indicate that the pertinent core is interruptible.

In the present embodiment, interrupt reception core information acquisition part 141 is able to update information in a memory in the same process without passing through shared memory 143 or the like.

### Interrupt Destination Core Setting Part 142

Interrupt destination core setting part 142 sets, based on the interrupt reception core information, a core to which ACC 12 is to raise an interrupt when finishing the processing.

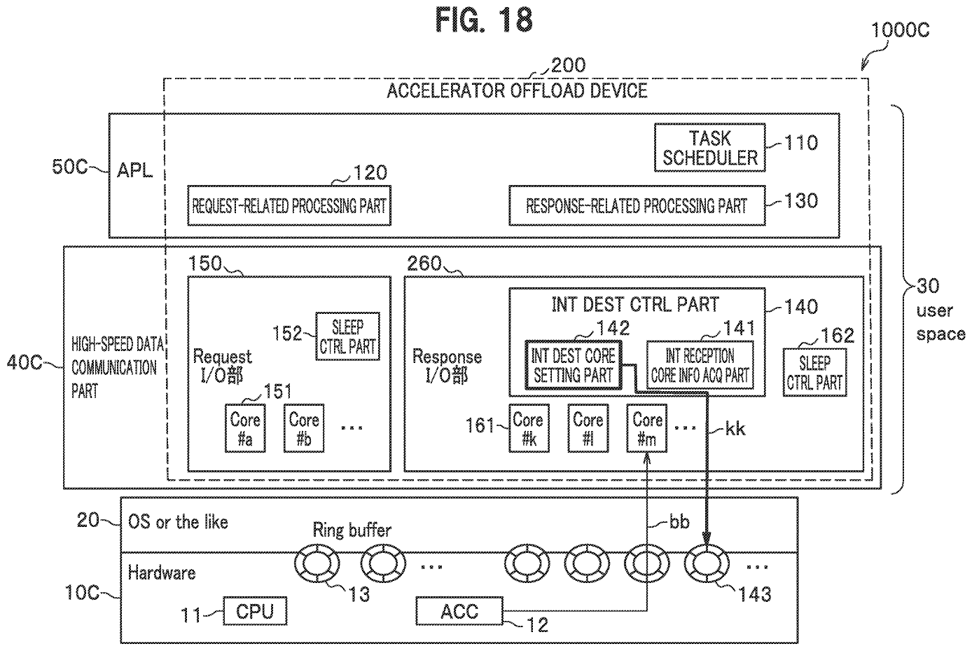

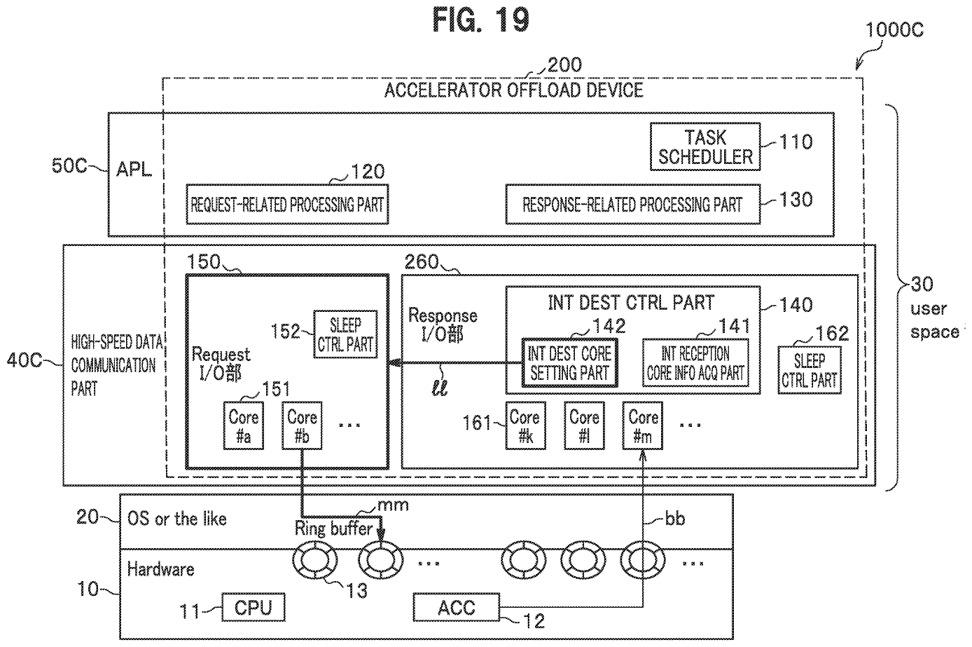

Interrupt destination core setting methods include a method in which a dedicated shared memory 143 is shared with ACC 12 (FIG. 18), and a method in which the response destination is designated at the time of requesting (FIG. 19).

FIG. 18 is an operation explanatory diagram of the accelerator offload system for explaining the method in which a dedicated shared memory 143 is shared with ACC 12. The same components as those in FIG. 14 are denoted by the same reference signs. The functional parts relevant to the operations are represented by the thick frames.

As illustrated in FIG. 18, interrupt destination core setting part 142 stores information on the cores currently interruptible in a shared memory 143 for interrupt destination core information (see reference sign kk in FIG. 18). ACC 12 references the shared memory 143 before raising the response and returns the response to a free core (in FIG. 18, returns the response to core #m of response I/O part 260).

FIG. 19 is an operation explanatory diagram of an accelerator offload system for explaining a method of designating the response destination at the time of requesting. The same components as those in FIG. 14 are denoted by the same reference signs. The functional parts relevant to the operations are represented by the thick frames.

As illustrated in FIG. 19, interrupt destination core setting part 142 has a shared memory (not illustrated) shared with request I/O part 150 and stores information on the cores currently interruptible in the shared memory (see reference sign ll in FIG. 19). Request I/O part 150 references the shared memory before issuing a request and imparts (see reference sign mm in FIG. 19) pertinent information to the request data. ACC 12, based on this information, returns (see reference sign bb in FIG. 19) the operation result of the request to the designated core for the response.

### Operations of Accelerator Offload Device 200 of Accelerator Offload System 1000C

Operations of accelerator offload device 200 of the accelerator offload system 1000C will be described.

The operations of accelerator offload device 200 is classified into: <preparation stage before the application actually processes data: core allocation>, <acquisition of information on whether each core of request I/O part 150 is “currently” capable of receiving an interrupt>, <until an interrupt destination core is set to the ACC and the interrupt is raised to the set core>, <from the start to the end of the processing of request-related processing part 120 and request I/O part 150>, and <from the start to the end of the processing of response-related processing part 130 and response I/O part 260>. Description thereof will be given in order.

### Preparation Stage Before Application Actually Processes Data: Core Allocation>

### 1

As illustrated in FIG. 19, task scheduler 110 allocates, of the available CPU cores provided from the OS, a part to the request-related processing, a part to the response-related processing, and a part to interrupt destination control part 140. For example, core #a, core #b, . . . , illustrated in FIG. 19, are allocated to request-related processing part 120 and request I/O part 150, and core #k, core #l, and core #m are allocated to response-related processing part 130 and response I/O part 260.

In the present embodiment, the cores allocated to response I/O part 260 are also used by interrupt destination control part 140.

### 2

Response-related processing part 130 receives, from task scheduler 110, information on the core numbers allocated to self. The reception methods are communication by inter-process communication and communication using shared memory (not illustrated).

### 3

The process of response-related processing part 130 stores the core number information on the cores allocated to response-related processing part 130 in its own memory (not illustrated) as interruptible core information. As this memory is accessible from any thread within the process of the response processing, the interruptible core information is able to be directly accessed by response I/O part 260 and even by interrupt destination control part 140.

The above described (1) to (3) are performed when a core is newly provided to the application from the OS even during the execution of the application. That is, when a core is newly provided, task scheduler 110 allocates the core to the request-related processing or the response-related processing. When there is a core newly allocated to the response-related processing, response-related processing part 130 updates and holds the interruptible core information held in its own memory.

On the contrary, when the OS acquires a core from the application, an operation reverse of the present procedure is performed. That is, task scheduler 110 reduces the cores of the request-related processing or the response-related processing by one. When a cores is reduced from the response-related processing, task scheduler 110 notifies the process of the response-related processing of the reduction. Response-related processing part 130, based on this information, deletes the pertinent core information from the interruptible core information held in its own memory.

### Until Interrupt Reception Core Information Acquisition Part 141 Acquires Information on Whether Each Core of Response I/O part 260 is “Currently” Capable of Receiving Interrupt

Premise 1: As described as Feature <3>, the core allocated to response I/O part 260 performs sleep when no processing is occurring, and in this state, is “capable of receiving an interrupt”. This is because contention with other processing does not occur even if an interrupt occurs and thus low latency is kept. At the stage where the application processing starts, all the cores allocated to response I/O part 260 are in an interrupt receivable state.

Premise 2: When a core allocated to response I/O part 260 does not perform sleep, the core is “incapable of receiving an interrupt”. This is because an interrupt in this state invariably causes processing contention and low latency is compromised.

### When Interrupt Reception Cores are Reduced

The procedure in the case where the interrupt reception cores are reduced is started when an interrupt occurs on a core allocated to response I/O part 260 and thus the “interrupt-receivable cores” are reduced.

### 1

Response I/O part 260, when receiving an interrupt from ACC 12, immediately inhibits interrupts on the pertinent core and releases the sleep.

### 2

On the pertinent core of response I/O part 260, interrupt reception core information acquisition part 141 becomes active and updates the interrupt-receivable core information. That is, an update of information is performed to indicate that the core for which interruption is inhibited (the core on which the oneself has become active) is now incapable of receiving an interrupt. This is performed by directly accessing the memory holding the interruptible core information provided in the preparation stage 1 described above.

### When Interrupt Reception Cores Are Increased

The procedure when the interrupt reception cores are increased is started when response-related processing part 130 finishes the processing and thus the “interrupt-receivable cores” are increased.

Response-related processing part 130, upon finishing the processing, on its core, activates interrupt reception core information acquisition part 141 and performs an information update to the memory provided in the preparation stage 1 described above. That is, the information is updated so as to indicate that the pertinent core is now interruptible.

Method 1: Information is appended to “allocated core information”.

Method 2: Information on the pertinent core is deleted from an “interrupt inhibition list”.

The difference between these methods is a difference in the data structure in the pertinent memory, and determination is made before operation.

### Until Interrupt Destination Core setting Part 142 Sets Interrupt Destination Core to ACC 12 and an Interrupt Is Raised to the Set Core

The procedure until interrupt destination core setting part 142 sets the interrupt destination core to ACC 12 and an interrupt is raised to the set core is started when a change occurs in the interrupt reception core information due to a change made to the allocation of cores by task scheduler 110 or when a change occurs in the interrupt reception core information due to starting/finishing response-related processing.

Interrupt reception core information acquisition part 141 checks which core is inhibited from being interrupted or permitted to be interrupted. Specifically, this is performed by accessing the memory in the process of the response processing, provided in the preparation stage 1 described above.

Thereafter, the behavior of “interrupt destination core setting part 142” depends on the “method of setting interrupt destination core”.

### Setting Method 1: When Dedicated Shared Memory is Shared with ACC

### 1

A shared memory for storing information on cores which are interruptible is provided separately from the ring buffer 13 used for exchanging the request and the response.

### 2

The information on the changed core is also written into the shared memory shared with ACC 12. Specifically, the shared memory is provided with an interrupt-receivable core list, and deletion and/or addition is performed therein.

### 3

ACC 12, after finishing the processing for a request, references the shared memory to determine a interrupt-receivable core.

### 4

ACC 12 writes the response into the ring buffer 13 between the interrupt-receivable core and ACC 12 and raises an interrupt to the core.

### Setting Method 2: When Information on Core to Which Response Is to be Raised Is Included in Request

### 1

A method in which the destination to which the response is to be raised is determined at the time of requesting and that information is passed to ACC 12 together with the request. A shared memory is provided between request-related processing part 120 and interrupt destination control part 140.

### 2

The shared memory between request-related processing part 120 and interrupt destination control part 140 is provided with an interrupt-receivable core list, and deletion and addition are performed therein.

### 3

Request-related processing part 120, prior to causing request I/O part 150 to issue the request, references the interrupt-receivable core list.

### 4

One core is selected from the interrupt-receivable core list, and the request is sent to ACC 12 through the ring buffer 13 in a state that the request information is accompanied by the information on the core.

### 5

ACC 12 receives the request, executes the operation, then writes response information into the ring buffer 13 provided between the response core specified in the accompanying information and ACC 12, and raises an interrupt to the core.

### From Start to End of Processing of Request-Related Processing Part 120 and Request I/O Part 150

The procedure from the start to the end of the processing of request-related processing part 120 and request I/O part 150 is started when task scheduler 110 allocates processing to request-related processing part 120.

Regarding the present procedure, only the basic operation which is not affected by the processing of interrupt destination control part 140 is described (as the processing in which interrupt destination core setting part 142 cooperates with the request has already been described, the description thereof is omitted).

### 1

Request-related processing part 120 executes the task allocated by task scheduler 110 as a thread. This processing differs depending on the applications.

### 2

When processing to be delegated to ACC 12 occurs in the execution of the request-related processing, request I/O part 150 starts processing. Note that this processing by request I/O part 150 is executed in the same thread on the same core as the core in which the request-related processing has been executed.

### 3

Request I/O part 150 writes the processing data and the request to the ring buffer 13 into the shared memory 143 shared with ACC 12 to finish the processing. The pertinent core is made to sleep and stands by for the next task to be allocated.

### 4

ACC 12 reads the contents of the ring buffer 13 and starts the processing.

### From Start to End of Processing of Response-Related Processing Part 130 and Response I/O part 260

Regarding the procedure from the start to the end of the processing of response-related processing part 130 and response I/O part 260, description will be given of the start to the end of the core allocated to response-related processing part 130.

As the coordination between response I/O part 260 and interrupt destination control part 140 has been already described, description thereof is omitted, and only the flow of data processing will be described.

### 1

ACC 12, upon finishing the operation, stores the processing result in the ring buffer 13 in the shared memory 143 shared with one core allocated to response I/O part 260 and raises an interrupt to the core.

### 2

Response I/O part 260 rises, and response I/O part 260 inhibits interrupts on the core.

### 3

Response I/O part 260 activates a thread of response-related processing part 130. Note that it runs on the same core as the core in which response I/O part 260 rises in response to the interrupt.

### 4

Response-related processing part 130 accesses the ring buffer 13 in the shared memory shared between the core and ACC 12 and reads the operation result.

### 5

Response-related processing part 130 releases the inhibition of interrupts on the core and performs post-processing. This processing differs depending on the application.

Note that after the above described (2), the operation of interrupt destination control part 140 is started as the same thread on the same core, and when the operation is finished, the processing shifts to the above described (3).

### Extended Function of Task Scheduler

A description will be given of an extended function of the task scheduler.

In any of the first embodiment and the second embodiment, task scheduler 110 (FIG. 1, FIG. 14) may allocate tasks so as to maximize the sleep time of each CPU core such that the CPU core can sleep as long as possible. That is, in many cases, a CPU has a CPU idle state control function such as the C-state and can transition to a power saving state by controlling a voltage, a frequency, and the like by hardware control. This CPU idle state control function can cause the CPU to transition into a deeper sleep state the longer the time during which the CPU can sleep. This makes it possible to expect a further power saving effect by performing optimum allocation that maximizes the sleep time.

In order to avoid a state in which a certain thread is performing other processing when an operation result is received from ACC 12, the timing of receiving the operation result from ACC 12 may be machine-learned from past results and inferred, and scheduling may be performed by using the inference result. For example, in the FEC processing in a vRAN, the FEC processing time varies depending on a data size or error rate. By learning this, it is possible to estimate a time from transmission of a request to the ACC to acquisition of a response.

In any of the first embodiment and the second embodiment, task scheduler 110 (FIG. 1, FIG. 14) may perform scheduling that increases the number of CPU cores to be used when the amount of the tasks increases (i.e. scaling out may be performed). In addition, when the amount of the tasks decreases, scheduling that reduces the number of CPU cores to be used may be performed (i.e., scaling in may be performed).

### Hardware Configuration

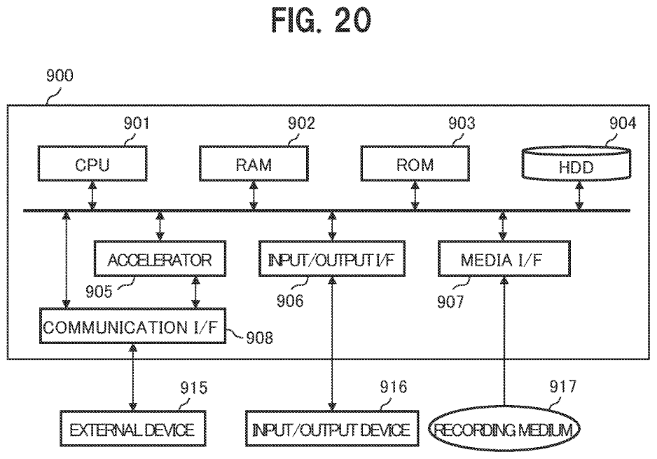

The accelerator offload devices 100 and 200 according to the above-described embodiments are implemented by a computer 900 having the configuration illustrated in FIG. 20, for example.

FIG. 20 is a hardware configuration diagram illustrating an example of computer 900 that implements functions of accelerator offload devices 100 and 200.

Computer 900 includes a CPU 901, a RAM 902, a ROM 903, an HDD 904, an accelerator 905, an input/output interface (I/F) 906, a media interface (I/F) 907, and a communication interface (I/F) 908. Accelerator 905 corresponds to accelerator (ACC) 12 in FIGS. 1 and 14.

Accelerator 905 is an accelerator (device) 12 (FIGS. 1 and 14) that processes at least one of data from communication I/F 908 and data from RAM 902 at high speed. Accelerator 905 may be of a type (look-aside type) that performs processing from CPU 901 or RAM 902 and then returns the processing result to CPU 901 or RAM 902. On the other hand, accelerator 905 may also be of a type (in-line type) that is interposed between communication I/F 908 and CPU 901 or RAM 902 and performs the processing.

Accelerator 905 is connected to an external device 915 via communication I/F 908. Input/output I/F 906 is connected to an input/output device 916. Media I/F 907 reads/writes data from/to a recording medium 917.

CPU 901 operates according to a program stored in ROM 903 or HDD 904 and controls each component of accelerator offload devices 100 and 200 in FIGS. 1 and 14 by executing the program (also referred to as an application or App as an abbreviation thereof) read into RAM 902. The program can be delivered via a communication line or delivered by being recorded in recording medium 917 such as a CD-ROM.

ROM 903 stores a boot program to be executed by CPU 901 when computer 900 is activated, a program that depends on the hardware of computer 900, and the like.

CPU 901 controls input/output device 916 including an input unit such as a mouse or a keyboard and an output unit such as a display or a printer via input/output I/F 906. CPU 901 acquires data from input/output device 916 and outputs generated data to input/output device 916 via input/output I/F 906. Note that a graphics processing unit (GPU) or the like may be used as a processor in conjunction with CPU 901.

HDD 904 stores a program to be executed by CPU 901, data to be used by the program, and the like. Communication I/F 908 receives data from another device via a communication network (e.g. network (NW)) and outputs the data to CPU 901 and also transmits data generated by CPU 901 to another device via the communication network.

Media I/F 907 reads a program or data stored in the recording medium 917 and outputs the program or data to the CPU 901 via the RAM 902. CPU 901 loads a program for the desired processing from recording medium 917 onto RAM 902 via media I/F 907 and executes the loaded program. Recording medium 917 is an optical recording medium such as a digital versatile disc (DVD) or a phase change rewritable disk (PD), a magneto-optical recording medium such as a magneto optical disk (MO), a magnetic recording medium, a conductor memory tape medium, a semiconductor memory, or the like.

For example, in a case where computer 900 functions as accelerator offload devices 100, 100A, or 100B configured as a device according to the present embodiment, CPU 901 of computer 900 implements the functions of accelerator offload devices 100 or 200 by executing the program loaded onto RAM 902. HDD 904 stores data in RAM 902. CPU 901 reads the program for the desired processing from recording medium 917 and executes the program. In addition, CPU 901 may read the program for the desired processing from another device via the communication network.

### Effects

As described above, an accelerator offload device 100 for offloading specific processing of an application program (APL 50) to an accelerator (ACC 12) includes: a request-related processing part 120 that performs predetermined processing required before offloading to the accelerator and notifies a request I/O part 150 of a request to perform offloading; request I/O part 150, which is composed of a CPU core and which performs request processing of notifying the accelerator of an offload request; a response I/O part 160 that is composed of a CPU core different from the CPU core and that performs response processing of notifying a response-related processing part 130 of operation completion of the accelerator; response-related processing part 130, which performs an operation described in the application program by using an operation result of the accelerator; and an interrupt destination control part 140 that sets an interrupt destination CPU core to be used by the accelerator when interrupting a CPU core of response I/O part 160.

In this way, the interrupt processing and the application processing, as well as the interrupt processing and another interrupt processing, are prevented from contending with each other to avoid the overhead of the contention and thus achieve low latency. That is, the request processing and the response processing are parallelized to prevent the contention between the application processing and the interrupt processing, thereby achieving low latency (Feature <1>). The application program dynamically sets the interrupt destination of the accelerator according to the processing state to avoid the contention between interrupt processes, thereby achieving low latency (Feature <1>).

With this, when a part of processing to be computed by the CPU is offloaded to the accelerator, the response of the operation result by the accelerator is able to be acquired at high-speed and with high resource utilization efficiency, thereby achieving the reduction of processing time (low latency) and the improvement of the CPU utilization efficiency.

In accelerator offload device 100 (FIG. 1), interrupt destination control part 140 includes: an interrupt reception core information acquisition part 141 that acquires information on the cores capable of being activated by an interrupt as interrupt reception core information; and an interrupt destination core setting part 142 that sets an interrupt destination core to ACC 12 based on the interrupt reception core information acquired by interrupt reception core information acquisition part 141.

In this way, interrupt reception core information acquisition part 141 manages information on the cores in charge of response-related processing part 130, acquires information on a core which is able to be immediately activated by an interrupt notification, and notifies interrupt destination core setting part 142 of the information. Interrupt destination core setting part 142, based on the interrupt reception core information, sets a core to which the accelerator is to raise an interrupt when finishing the processing. As the interrupt destination of the accelerator is dynamically controlled by the application program, the interrupt processing and the application processing, as well as the interrupt processing and another interrupt processing, are prevented from contending with each other to avoid the overhead of the contention and thus achieve low latency.

In accelerator offload device 100 (FIG. 1), interrupt destination control part 140 is provided in the application program and sets the interrupt destination CPU core of the accelerator according to the application processing state.

In this way, as the interrupt destination of the accelerator is dynamically controlled by the application program, the interrupt processing and the application processing, as well as the interrupt processing and another interrupt processing, are prevented from contending with each other to avoid the overhead of the contention and thus achieve low latency.

In accelerator offload device 100 (FIG. 1), a dedicated shared memory 143 is provided between interrupt destination core setting part 142 and the accelerator (ACC 12), interrupt destination core setting part 142 writes interruptible core information into the shared memory 143, and the accelerator references the shared memory 143 to raise an interrupt to a free core.

In this way, interrupt destination core setting part 142 is able to directly write the core information into the shared memory 143 on hardware 10 without passing through request I/O part 150 of high-speed data communication part 40 composed of middleware.

In the accelerator offload device 100 (FIG. 1), interrupt destination core setting part 142, at the time of requesting, designates a response destination to which the accelerator (ACC 12) is to return the response.

High-speed data communication part 40 has a shared memory for high-speed data transfer with the application program. Interrupt destination core setting part 142 stores information on the cores currently interruptible by using (diverting) the shared memory. This is advantageous in that it is not necessary to provide a dedicated shared memory 143 between interrupt destination core setting part 142 and the accelerator (ACC 12).

In accelerator offload device 200 (FIG. 14), interrupt destination control part 140 is provided in a response I/O part 260 outside the application program and sets an interrupt destination CPU core of the accelerator according to an application processing state without delivering interrupt reception information from response I/O part 260 to the application program.

In this way, as it is possible to perform the interrupt destination control without delivering the interrupt reception information from response I/O part 260 to the application, it is advantageous in that the interrupt destination control is performed with high-speed and high efficiency.

In the accelerator offload devices 100 (FIGS. 1) and 200 (FIG. 14), request I/O part 150 and/or response I/O part 260 includes a sleep control part 162 that, when there is no task to be operated on a CPU, causes a thread operating on the CPU to sleep.

In this way, by performing sleep when there is no processing in order to reduce an increase in the power consumption due to parallelization, it is possible to achieve high power saving. In addition, by controlling the CPU operating frequency and the CPU idle state, it is possible to achieve further high power saving.

Note that, in the processing described in the above embodiments, all or some pieces of the processing described as those to be automatically performed may be manually performed, or all or some pieces of the processing described as those to be manually performed may be automatically performed by a known method. Further, processing procedures, control procedures, specific name, and information including various types of data and parameters described in the specification and the drawings can be freely changed unless otherwise specified. The constituent elements of the devices illustrated in the drawings are functionally conceptual ones and are not necessarily physically configured as illustrated in the drawings. In other words, a specific form of distribution and integration of individual devices is not limited to the illustrated form, and all or part thereof can be functionally or physically distributed and integrated in any unit according to various loads, usage conditions, and the like.

Some or all of the configurations, functions, processing parts, processing means, and the like described above may be implemented by hardware by, for example, being designed in an integrated circuit. Each of the configurations, functions, and the like may be implemented by software for interpreting and executing a program for causing a processor to implement each function. Information such as a program, table, and file for implementing each function can be held in a recording device such as a memory, hard disk, or solid state drive (SSD) or a recording medium such as an integrated circuit (IC) card, secure digital (SD) card, or optical disc.

### REFERENCE SIGNS LIST

10 Hardware
11 CPU
12 ACC (accelerator)
13 Ring buffer
40 High-speed data communication part
50 APL (application program)
100, 200 Accelerator offload device
110 Task scheduler
120 Request-related processing part
130 Response-related processing part
150 Request I/O part
151 CPU core (core #a, core #b, . . . )
160 Response I/O part
161 CPU core (core #k, core #l, . . . )
152, 162 Sleep control part
30 User space
151, 161 CPU core
1000 to 1000C Accelerator offload system

1-8. (canceled)

9. An accelerator offload device that offloads specific processing of an application program to an accelerator, the accelerator offload device comprising:
a request-related processing part;
a request I/O part;
a response I/O part;
a response-related processing part, and an interrupt destination control part,
wherein the request-related processing part is configured to perform predetermined processing required before performing offloading to the accelerator and then notify the request I/O part of a request to perform offloading,
wherein the request I/O part is configured to operate on a first CPU core and configured to perform request processing of notifying the accelerator of an offload request,
wherein the response I/O part is configured to operate on a second CPU core different from the first CPU core to perform response processing of notifying the response-related processing part of operation completion of the accelerator,
wherein the response-related processing part is configured to perform an operation described in the application program by using an operation result of the accelerator, and
wherein the interrupt destination control part is configured to set an interrupt destination CPU core to which the accelerator is to raise an interrupt and which is to be used as the second CPU core.

10. The accelerator offload device according to claim 9,
wherein the interrupt destination control part comprises:
an interrupt reception core information acquisition part configured to acquire information on CPU cores capable of being activated by an interrupt as interrupt reception core information; and
an interrupt destination core setting part configured to set the interrupt destination CPU core based on the interrupt reception core information acquired by the interrupt reception core information acquisition part.

11. The accelerator offload device according to claim 9,
wherein the interrupt destination control part is provided in the application program and configured to set the interrupt destination CPU core according to an application processing state.

12. The accelerator offload device according to claim 10,
wherein a dedicated shared memory is provided between the interrupt destination core setting part and the accelerator,
wherein the interrupt destination core setting part is further configured to write interruptible core information into the shared memory, and
wherein the accelerator references the shared memory to determine a free CPU core as the interrupt destination CPU core and raise an interrupt to the free CPU core.

13. The accelerator offload device according to claim 10,
wherein the interrupt destination core setting part is configured to set the interrupt destination CPU core at the time of requesting offloading.

14. The accelerator offload device according to claim 9,
wherein the response I/O part is provided outside the application program and the interrupt destination control part is provided in the response I/O part, and
wherein the interrupt destination control part is configured to set the interrupt destination CPU core according to an application processing state without delivering interrupt reception information from the response I/O part to the application program.

15. The accelerator offload device according to claim 9,
wherein the request I/O part and/or the response I/O part includes a sleep control part configured to, when there is no task to be operated on a corresponding CPU core, cause a thread operating on the corresponding CPU core to sleep.

16. An accelerator offload method of an accelerator offload device that offloads specific processing of an application program to an accelerator, the accelerator offload method comprising steps of:
performing predetermined processing required before performing offloading to the accelerator and then making a notification of a request to perform offloading;
performing, by a first CPU core, request processing of notifying the accelerator of an offload request;
performing, by a second CPU core different from the first CPU core, response processing of notifying of operation completion of the accelerator;
performing an operation described in the application program by using an operation result of the accelerator; and
setting an interrupt destination CPU core to which the accelerator is to raise an interrupt and which is to be used as the second CPU core.

17. The accelerator offload method according to claim 16, further comprising:
acquiring information on CPU cores capable of being activated by an interrupt as interrupt reception core information; and
setting the interrupt destination CPU core based on the acquired interrupt reception core information.

18. The accelerator offload method according to claim 16,
wherein the step of setting the interrupt destination CPU core is performed by the application program according to an application processing state.

19. The accelerator offload method according to claim 17, further comprising:
writing interruptible core information into a shared memory, and referencing, by the accelerator, the shared memory to determine a free CPU core as the interrupt destination CPU core and raise an interrupt to the free CPU core.

20. The accelerator offload method according to claim 17,
wherein the step of setting the interrupt destination CPU core is performed at the time of the step of performing request processing of notifying the accelerator of the offload request.

21. The accelerator offload method according to claim 16,
wherein the step of setting the interrupt destination CPU core is performed from outside the application program according to an application processing state without delivering interrupt reception information to the application program.

22. The accelerator offload method according to claim 16, further comprising:
when there is no task to be operated on a CPU core, causing a thread operating on the CPU core to sleep.
